(19) United States
(12) Patent Application Publication
(10) Pub. No.: US 2020/0266979 A1
(43) Pub. Date: Aug. 20, 2020

(54) INFORMATION RECORDING DEVICE AND HOST DEVICE

(71) Applicant: Toshiba Memory Corporation, Minato-ku (JP)

(72) Inventor: Shinichi MATSUKAWA, Shinagawa (JP)

(73) Assignee: Toshiba Memory Corporation, Minato-ku (JP)

(21) Appl. No.: 16/550,971

(22) Filed: Aug. 26, 2019

(30) Foreign Application Priority Data
Feb. 20, 2019 (JP) 2019-028796

(51) Int. Cl. H04L 9/08; H04L 9/32; G06F 21/44

(52) U.S. Cl. CPC H04L 9/0866; G06F 21/44; H04L 9/3263; H04L 9/0869

(57) ABSTRACT

According to one embodiment, an information recording device includes a memory and a controller. The memory includes a secret recording section. The secret recording section includes a first area and a second area. The controller is configured to control the memory. The controller is configured to permit access to the first area in a case where a first authentication process related to the secret recording section is performed and configured to permit access to the second area in a case where a second authentication process related to the secret recording section is performed.

### CROSS-REFERENCE TO RELATED APPLICATION

This application is based upon and claims the benefit of priority from Japanese Patent Application No. 2019-028796, filed Feb. 20, 2019; the entire contents of which are incorporated herein by reference.

### FIELD

Embodiments described herein relate generally to an information recording device and a host device.

### BACKGROUND

A content distribution system in which content data such as books, newspapers, music, or moving pictures recorded in an information recording device through a host device is able to be viewed by another host device is known. Such a content distribution system is expected to further improve a security level.

### BRIEF DESCRIPTION OF THE DRAWINGS

FIG. 1 is a block diagram showing a constitution of an information recording device of a first embodiment.

FIG. 2 is an equivalent circuit diagram showing a constitution of a NAND flash memory of the first embodiment.

FIG. 3 is a block diagram showing a constitution of a host device of the first embodiment.

FIG. 4 is a schematic diagram for describing a manufacturing process of a memory card and a method of writing a media device key and a media device key certificate in the first embodiment.

FIG. 5 is a block diagram for describing an operation of writing content data to the memory card in the first embodiment.

FIG. 6 is a block diagram for describing an operation of reading the content data from the memory card in the first embodiment.

FIG. 7 is a diagram showing area setting of a secret recording section of the first embodiment.

FIG. 8 is a diagram showing an access condition management table of the first embodiment.

FIG. 9 is a flowchart showing an operation of a first authentication process of the first embodiment.

FIG. 10 is a flowchart showing an operation of a second authentication process of the first embodiment.

FIG. 11 is a diagram showing a host device key certificate of the first embodiment.

FIG. 12 is a flowchart showing a flow of a process of the host device in a case where the content data is recorded in the first embodiment.

FIG. 13 is a flowchart showing a flow of a process of the memory card in a case where the content data is recorded in the first embodiment.

FIG. 14 is a block diagram showing a constitution of the information recording device of a second embodiment.

FIG. 15 is a diagram showing an arca change of a secret recording section of the second embodiment.

FIG. 16 is a block diagram showing a constitution of the information recording system of a third embodiment.

FIG. 17 is a block diagram for describing an operation of writing content data in a memory card in a fourth embodiment.

FIG. 18 is a block diagram for describing an operation of reading content data from the memory card in the fourth embodiment.

### DETAILED DESCRIPTION OF THE INVENTION

According to one embodiment, an information recording device includes a memory and a controller. The memory includes a secret recording section. The secret recording section includes a first area and a second area. The controller is configured to control the memory. The controller is configured to permit access to the first area in a case where a first authentication process related to the secret recording section is performed. The controller is configured to permit access to the second area in a case where a second authentication process related to the secret recording section is performed.

Hereinafter, information recording devices and host devices of embodiments will be described with reference to the drawings. In the following description, components having the same or similar functions are denoted by the same reference numerals. In addition, duplicate description of these components may be omitted in some cases. In the present specification, “based on XX (or on the basis of XX)” means “based on at least XX,” and also includes a case based on another element in addition to XX. In addition, “based on XX (or on the basis of XX)” is not limited to “based directly on XX”, but also represents “based on something that is generated by an arithmetic operation or another process being performed on XX”. Here, “XX” is an arbitrary element (for example, arbitrary information).

In the present specification, “encrypt/decrypt using YY” is not limited to a case in which encryption/decryption is performed directly using YY (that is, using YY itself as key information), and also includes a case in which encryption/decryption is performed indirectly using YY (for example, using key information that is generated by an arithmetic operation or another process being performed on YY). “YY” is an arbitrary element (for example, arbitrary information). In the present specification, “write” and “record” are used as having the same meaning each other. Therefore, these terms are interchangeable. In the present specification, “connect” is not limited to a mechanical connection, and also includes an electrical connection or a connection enables wired or wireless communication.

### First Embodiment

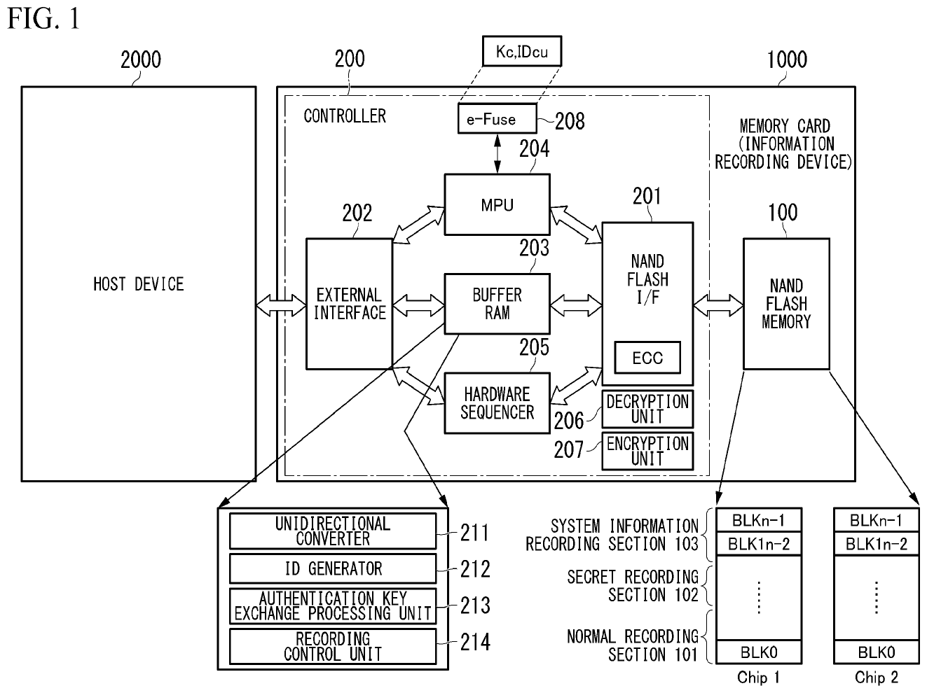

An information recording device 1000 and a host device 2000 according to an information recording system of the first embodiment will be described with reference to FIGS. 1 to 13. The information recording device 1000 and the host device 2000 are, for example, devices that are able to be used with SeeQVault (registered trademark) or its subsequent technology, and are devices that handle moving image data such as a high vision broadcast and a 4K broadcast as content data. However, the information recording device 1000 and the host device 2000 are not limited to the example described above, and may be devices that handle other moving image data or devices that handle other types of content data such as books, newspapers, or music.

<1. Constitution of Information Recording Device>

First, an overview of the information recording device 1000 will be described.

FIG. 1 is a block diagram showing the constitution of the information recording device 1000 of the first embodiment. The information recording device 1000 of the present embodiment is a non-volatile memory system such as a memory card (for example, an SD card (registered trademark)). Therefore, in the following description, the information recording device 1000 will be referred to as a “memory card 1000”. However, the information recording device 1000 is not limited to a memory card, and may be a solid state drive (SSD), a universal serial bus (USB) memory, a NAND flash memory chip, or a hard disk drive (HDD).

The memory card 1000 is configured to store, for example, encrypted content data. The memory card 1000 is configured to connect to the host device 2000, and to execute a predetermined authentication key exchange process between the memory card 1000 and the host device 2000. In a case where the authentication key exchange process is completed, writing of data from the host device 2000 to a system information recording section 103 and a secret recording section 102 of the memory card 1000, and reading of data from the system information recording section 103 and the secret recording section 102 of the memory card 1000 to the host device 2000 become possible. In addition, reading of, by the host device 2000 or a reproduction device connected to the host device 2000, the encrypted content data and data necessary for decrypting the encrypted content data stored in the memory card 1000, and reproduction of the content data become possible.

In the present embodiment, for the authentication key exchange process between the memory card 1000 and the host device 2000, the memory card 1000 is configured to store media device key Kmd_i that is a secret key of a public key cryptosystem and a media device key certificate Certmedia that is data including a public key of the public key cryptosystem. A media device key certificate ID (IDm_cert) that is identification information unique to a certificate is embedded in the media device key certificate Certmedia.

Next, the constitution of the information recording device 1000 will be described.

The memory card 1000 includes, for example, a NAND flash memory 100 (hereinafter, referred to as a “memory 100”) and a controller 200 that controls a read operation, a write operation, and the like for the memory 100. Here, a case in which a NAND flash memory is adopted as an example of the memory 100 will be described, but other memory devices capable of storing data in a non-volatile manner (a resistance change memory, a ferroelectric memory, a magnetic resistance memory, a phase change memory, or the like) is also able to be adopted as the memory 100.

For example, the controller 200 includes a NAND flash interface unit 201 for transmitting data between the controller 200 and the memory 100, an external interface unit 202 for transmitting data between an external device such as the host device 2000, and the controller 200, a buffer random access memory (RAM) 203 for temporarily storing read data, write data, and the like, a micro processing unit (MPU) 204 for data transmission control, a hardware sequencer 205 used for sequence control of reading and writing of firmware (FW) in the memory 100, and the like, a decryption unit 206, an encryption unit 207, and a fuse circuit 208.

The NAND flash interface unit 201 includes, for example, an error correction circuit (ECC). When writing data in the memory 100, the NAND flash interface unit 201 calculates an error correction code using the error correction circuit, and writes the data and the error correction code in the memory 100. When reading data from the memory 100, the NAND flash interface unit 201 calculates a syndrome from the data and the error correction code, and corrects a data error within a predetermined error correction capability range.

The firmware necessary for the controller 200 is automatically read from the memory 100 and transmitted to a data register (buffer RAM) 203 in an initialization operation (power on initial setup operation) that is automatically executed after an input of power. The read control is performed by the hardware sequencer 205. Note that the firmware may he stored in a ROM in the controller 200. The firmware of the present embodiment includes a unidirectional converter 211, an ID generator 212, an authentication key exchange processing unit 213, a recording control unit 214 (read and write control unit), and the like, as described later.

The fuse circuit 208 stores a controller key Kc and a controller unique ID (IDcu) for identifying the controller 200. The controller key Kc and the controller unique ID (IDcu) are used for generating a controller unique key Kcu as described later. The controller unique key Kcu is used for encrypting the above-mentioned media device key Kmd_i when recording the media device key Kmd_i in the system information recording section 103 of the memory card 1000. The controller unique key Kcu is generated in the unidirectional converter 211 using the controller key Kc and the controller unique ID (IDcu) as input values. That is, the unidirectional converter 211 is an aspect of a controller unique key generation unit for generating the controller unique key Kcu.

The ID generator 212 (controller identification information generation unit) generates a public control unique ID (IDcntr) transmitted to the outside, using the controller key Kc and the controller unique ID (IDcu) as input values.

The authentication key exchange processing unit 213 executes an authentication key exchange process between the memory card 1000 and the host device 2000 on the basis of the media device key Kmd_i and the media device key certificate Certmedia. The authentication key exchange process will be described in detail later.

The recording control unit 214 executes the read operation and the write operation on the memory 100 on the basis of a command received from the host device 2000. For example, in a case where the recording control unit 214 receives a write connnand designating a logical address in the memory 100 and data to be written (write data) from the host device 2000, the recording control unit 214 records the data to be written at a storage position in the memory 100 indicated by the logical address designated by the write command On the other hand, in a case where the recording control unit 214 receives a read command designating a logical address of the memory 100 from the host device 2000, the recording control unit 214 reads data to be read (read data) from a storage position in the memory 100 indicated by the logical address designated by the read command, and transmits the read data to the host device 2000. Note that an operation of the recording control unit 214 of the present embodiment will be described in detail later.

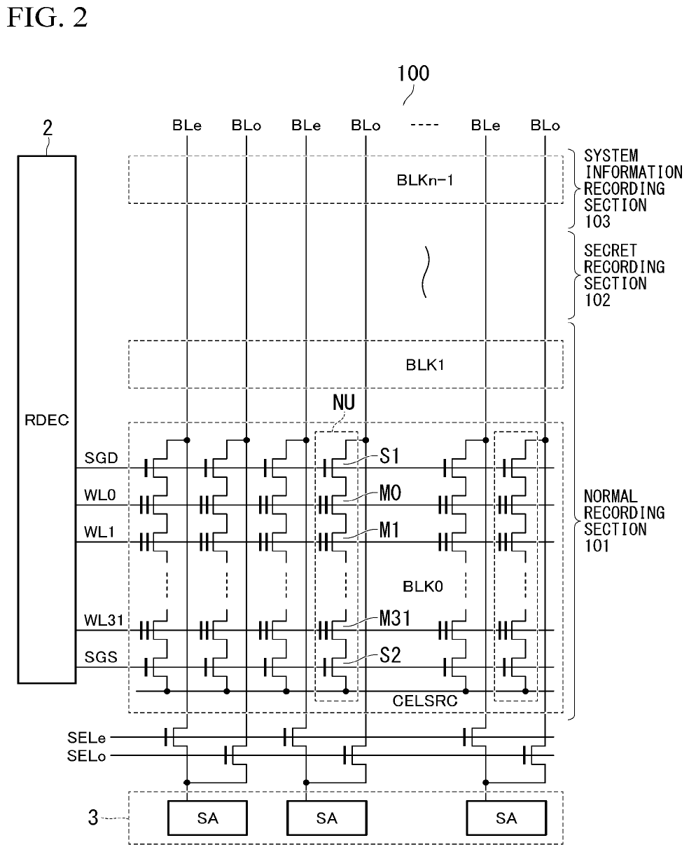

FIG. 2 is an equivalent circuit diagram showing a constitution of the memory 100. The memory 100 is constituted by a plurality of NAND cell units (NAND strings) NU in which a plurality of electrically rewritable non-volatile memory cells (32 memory cells in an example of the figure) M0 to M31 are arranged by being connected in series.

One end of the NAND cell unit NU is connected to a bit line BLo (or BLe) through a selection gate transistor S1. The other end of the NAND cell unit NU is connected to a common source line CELSRC through a selection gate transistor S2. Control gates of the memory cells M0 to M31 are connected to word lines WL0 to WL31, respectively. Gates of the selection gate transistors S1 and S2 are connected to selection gate lines SGD and SGS, respectively.

A set of the NAND cell units arranged in a word line direction constitutes a block serving as a minimum unit of data erasure, and a plurality of blocks BLK0 to BLKn-1 arc disposed in a direction of the bit line as shown in the figure. A part of the plurality of blocks BLK is set as a normal recording section 101 that a user (the host device 2000) is able to freely access without a special authentication process. Another part of the plurality of blocks BLK is set as a secret recording section 102 that is able to be accessed after a predetermined authentication key exchange process. Yet another part of the plurality of blocks BLK is set as a system information recording section 103 for recording information that is set in advance at the time of manufacturing the memory card. Each of the normal recording section 101, the secret recording section 102, and the system information recording section 103 allocates a logical address. The designation of the logical address of the secret recording section 102 is permitted only in a case where the authentication key exchange process described later is completed.

Note that the “secret recording section” in the present specification is not limited to a recording section that requires the authentication key exchange process. The “secret recording section” may mean a recording section that is able to be accessed in a case where an authentication process is performed, and may be a recording section that is able to be accessed in a case where another type of authentication process is performed. The “authentication process” is not a process of confirming a connection state or an operation state between the information recording device and the host device, but is a process of confirming whether or not the other party has a justifiable right. The authentication key exchange process is an example of the “authentication process”. According to another viewpoint, the “secret recording section” is a recording section in which access is restricted until a predetermined additional process is performed, for example, in a state in which access to the normal recording section 101 is possible. In addition, “access is possible” means, for example, that at least one of writing and reading of information to and from a predetermined area is possible.

In the present embodiment, in the normal recording section 101, data of 2 bits or more is able to be stored in one memory cell. On the other hand, in the secret recording section 102 and the system information recording section 103, data of only one bit is able to be stored in one memory cell from a viewpoint of securing data reliability. In addition, in the normal recording section 101, a correspondence between a logical address and a physical address is dynamically changed according to a data update. On the other hand, in the secret recording section 102 and the system information recording section 103, control may be performed so as to statically fix the correspondence between the logical address and the physical address from the viewpoint of securing the data reliability.

A sense amplifier circuit 3 provided for reading and writing cell data is disposed on one end side of the bit lines BLe and BLo. In addition, a row decoder 2 that performs selection driving on the word line and the selection gate line is disposed on one end side of the word line. The figure shows a case in which adjacent even number bit lines BLe and odd number bit lines BLo are selectively connected to each sense amplifier SA of the sense amplifier circuit 3 by bit line selection circuits SELe and SELo.

<3. Constitution of Host Device>

Next, the constitution of the host device 2000 will be described.

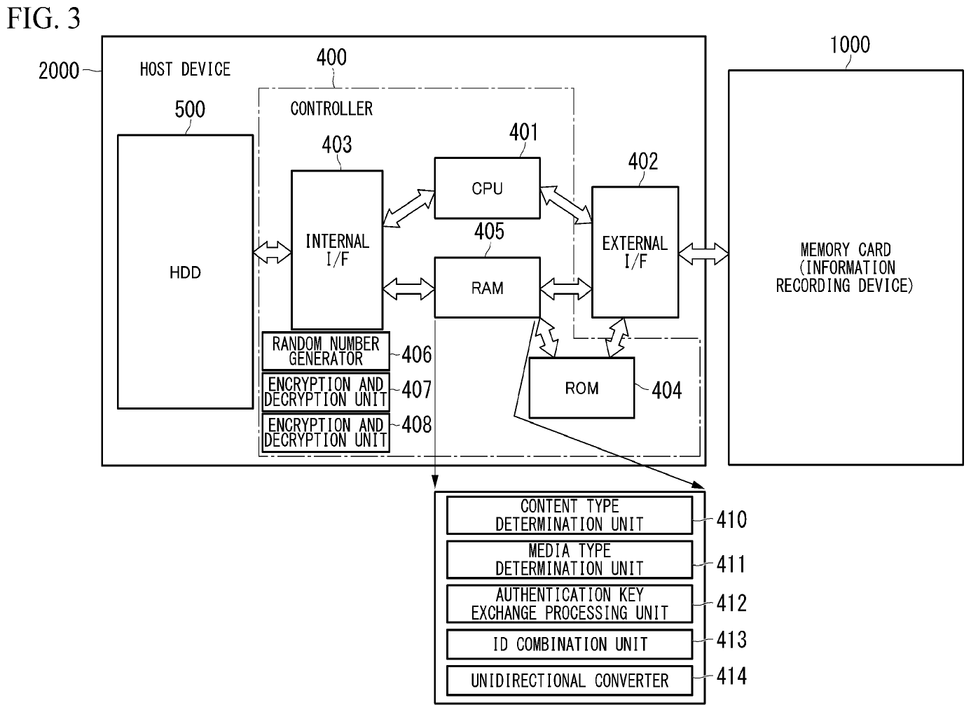

FIG. 3 is a block diagram showing the constitution of the host device 2000 of the first embodiment. The host device 2000 of the present embodiment is, for example, an information processing device such as a television receiver, a recorder for a television receiver, a personal computer, a tablet terminal device, or a smartphone. Note that the host device 2000 may have at least one of a function of writing the content data in the memory card 1000 and a function of reading the content data written in the memory card 1000. In a case where the host device 2000 has the function of writing the content data in the memory card 1000, the host device 2000 has, for example, a tuner or an interface unit (not shown) and is configured to receive content data transmitted from an external device.

In the present embodiment, the host device 2000 includes a controller 400 that controls the entire host device 2000 and controls the read operation, the write operation, and the like for the memory card 1000, an external interface unit 402 for performing data transmission between the controller 400 and the memory card 1000, and an HDD 500 in which the content data is recorded. Note that the HDD 500 is not an essential component of the host device 2000, and may be omitted.

The controller 400 includes, for example, a central processing unit (CPU) 401 that controls the read operation and the write operation for the memory card 1000, an internal interface unit 403 for data transmission between the controller 400 and the HDD 500, a read only memory 404 (ROM), a RAM 405, a random number generator 406, an encryption and decryption unit 407, and an encryption and decryption unit 408.

The firmware for operating the host device 2000 is recorded in the ROM 404. In addition, the ROM 404 also stores a host device key Khd_j and a host device key certificate Certhost which will be described later. The host device key Khd_j is a secret key of the public key crypto system. The host device key certificate Certhost is data including a public key paired with the host device key Khd_j. The host device key certificate Certhost will be described in detail later. The host device key Khd_j and the host device key certificate Certhost may be stored in the ROM or the HDD 500 provided outside the controller 400.

The firmware necessary for the controller 400 is automatically read from the ROM 404 and transmitted to the RAM 405 in the initialization operation that is automatically executed after the input of the power. The firmware of the present embodiment includes, for example, a content type determination unit 410, a media type determination unit 411, an authentication key exchange processing unit 412, an ID combination unit 413, a unidirectional converter 414, and the like.

Here, the host device 2000 of the present embodiment handles content data conforming to a first standard (hereinafter referred to as “content data of the first standard”) and content data conforming to a second standard (hereinafter referred to as “content data of the second standard”) different from the first standard. An example of the first standard content data is moving image data conforming to a high definition broadcast or a previous standard. An example of the second standard content data is moving image data conforming to a 4K broadcast standard.

The content type determination unit 410 determines whether the content data (for example, the content data to be written in the memory card 1000 or the content data to be read from the memory card 1000) handled by the host device 2000 is the content data of the first standard or the content data of the second standard. For example, the content type determination unit 410 determines whether the content data which is a target is the content data of the first standard or the content data of the second standard on the basis of identification information included in a header of the content data or identification information associated with the content data and stored in the HDD 500 or the memory 100 of the memory card 1000 or the like.

The media type determination unit 411 determines whether or not the memory card 1000 is an information recording device corresponding to the content data of the first standard, and whether or not the memory card 1000 is an information recording device corresponding to the content data of the second standard. “Corresponding to the content data of the first standard or second standard” means that an information recording device satisfies a predetermined standard required to protect the content data of the first standard or second standard, and means, for example, an information recording device conforming to a predetermined standard.

For example, the media type determination unit 411 transmits a predetermined first command for determining the type of media to the memory card 1000. In addition, in a case where there is a predetermined response to the first command from the memory card 1000, the media type determination unit 411 determines that the memory card 1000 is the information recording device corresponding to the content data of the first standard. On the other hand, in a case where there is no predetermined response to the first command from the memory card 1000, the media type determination unit 411 determines that the memory card 1000 is not the information recording device corresponding to the content data of the first standard.

In addition, the media type determination unit 411 transmits a predetermined second command for determining the type of the media to the memory card 1000. In a case where there is a predetermined response to the second command from the memory card 1000, the media type determination unit 411 determines that the memory card 1000 is the information recording device corresponding to the content data of the second standard. On the other hand, in a case where there is no predetermined response to the second command from the memory card 1000, the media type determination unit 411 determines that the memory card 1000 is not the information recording device corresponding to the content data of the second standard.

The authentication key exchange processing unit 412 is configured to execute an authentication key exchange process with the authentication key exchange processing unit 213 of the memory card 1000 through the interface units 402 and 202 and a secure channel. The authentication key exchange processing unit 412 transmits the host device key certificate Certhost to the authentication key exchange processing unit 213 of the memory card 1000 as a part of the authentication key exchange process. In addition, the authentication key exchange processing unit 412 receives the media device key certificate Certmedia from the authentication key exchange processing unit 213 of the memory card 1000 as a part of the authentication key exchange process, and outputs the media device key certificate ID (IDm_cert) included in the received media device key certificate Certmedia. Note that the authentication key exchange process will be described in detail later.

The ID combination unit 413 is configured to generate a memory card unique ID (IDmc) based on the public controller unique ID (IDcntr) and the media device key certificate ID (IDm_cert). The ID combination unit 413 functions as an identification information generation unit that generates the memory card unique ID (IDmc) on the basis of the controller unique ID (IDcntr) and the media device key certificate ID (IDm_cert). The ID combination unit 413 of the present embodiment generates another new ID by simply combining two IDs. Instead of such a simple combination, for example, a unidirectional function or an encryption algorithm may be used to generate a new ID. The memory card unique ID (IDmc) is an example of media identification information (media ID) that is able to identify media.

The unidirectional converter 414 generates a media unique key Kmu by a unidirectional function using the memory card unique ID (IDmc) and a media key Km generated by the random number generator 406 as inputs.

The random number generator 406 generates a random number and generates the media key Km and a title key Kt on the basis of the generated random number. The encryption and decryption unit 407 encrypts the title key Kt by the above-described media unique key Kmu. The encryption and decryption unit 408 encrypts the content data by the title key Kt, and obtains encrypted content data Enc(Kt, C) which will be described later.

Note that the media unique key Kmu is generated by the host device 2000, and is used as an encryption key for encrypting the title key Kt in the present embodiment. However, similarly to a content protection technology of the related art, the media unique key Kmu recorded in the secret recording section 102 of the memory card 1000 may be directly used for encryption of content data C is also possible. In this case, the media unique key Kmu used for the encryption of the content data C of the first standard is an example of each of “first key information” and “first concealment information” instead of a first media key KmA which will be described later. In addition, the media unique key Kmu used for the encryption of the content data C of the second standard is an example of each of “second key information” and “second concealment information” instead of a second media key KmB which will be described later.

In addition, a double cryptosystem in which a user key Ku unique to the user is encrypted by the media unique key Kmu, a content key Kct is encrypted by the user key Ku, and the content data is encrypted by the content key Kct may be used. In addition, instead of generating the media key Km and the title key Kt in the host device 2000, the media key Km and the title key Kt may be written in the memory card 1000 in advance or given from an external device (not shown).

<4. Manufacturing Process of Memory Card 1000>

Next, the manufacturing process of the memory card 1000 and a method of writing the media device key Kmd_i and the media device key certificate Certmedia will be described.

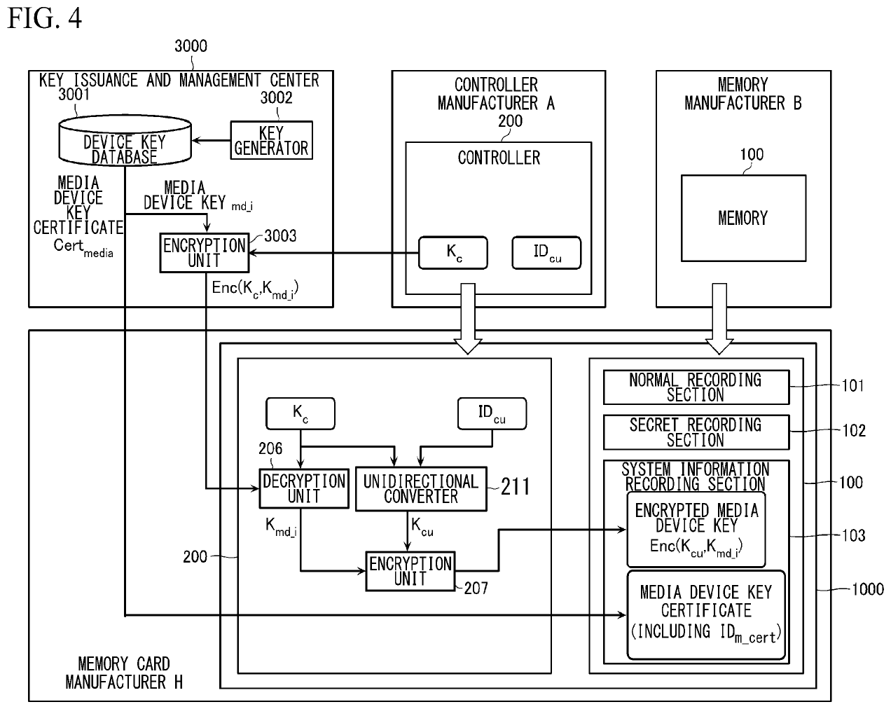

FIG. 4 is a schematic diagram for describing the manufacturing process of the memory card 1000 and the method of writing the media device key Kmd_i and the media device key certificate Certmedia. The media device key Kmd_i and the media device key certificate Certmedia to be written to the memory card 1000 arc provided from a key issuance and management center 3000 to a memory card manufacturer H, and are written in the system information recording section 103 of the memory 100 of the memory card 1000 via the controller 200. Note that, although not shown in FIG. 1, the memory card 1000 is able to be connected to an apparatus (PC, mobile phone, public terminal device, or the like) having a predetermined communication function. Data issued from the key issuance and management center 3000 is written to the memory card 1000 through the apparatus having such a communication function.

In the manufacturing of the memory card 1000, a controller manufacturer A provides the controller 200 to the memory card manufacturer H, and a memory manufacturer B provides the memory 100 to the memory card manufacturer H. Note that any or all of the manufacturers A, B, and H may be the same company in some cases. The memory card manufacturer H writes necessary information in the memory 100 in order to cause the memory card 1000 to be brought into a state in which the memory card 1000 is able to operate.

At the time of manufacturing of the controller 200, the controller manufacturer A writes the controller key Kc and the controller unique ID (IDcu) as the concealment information in the controller 200. The controller key Kc may be used as a common key by a plurality of controllers 200 from a reason of a manufacturing process or the like. On the other hand, the controller unique ID is different for each controller 200, and the controller unique key generated in one controller 200 and the controller unique key generated in another controller 200 are always different.

The controller manufacturer A discloses data of the control key Kc given to the controller 200 to the key issuance and management center 3000. Note that the controller key Kc is transmitted from the controller manufacturer A to the key issuance and management center 3000 using PGP encryption or the like.

The key issuance and management center 3000 includes a key generator 3002 that generates the media device key Kmd_i and the media device key certificate Certmedia, a device key database 3001 that manages the generated media device key Kmd_i and the media device key certificate Certmedia, and an encryption unit 3003 that encrypts the media device key Kmd_i using the controller key Kc received from the controller manufacturer A.

The controller key Kc is used for encrypting the media device key Kmd_i in the key issuance and management center 3000. The media device key Kmd_i is generated by the key generator 3002 and then stored in the device key database 3001. The encryption unit 3003 is supplied with the corresponding media device key Kmd_i from the device key database 3001, encrypts the media device key Kmd_i by the controller key Kc, and generates an encrypted media device key Enc(Kc, Kmd_i).

The controller key Kc is information that only the controller manufacturer A and the key issuance and management center 3000 are able to know. However, in order to reduce damage when information of the controller key Kc leaks to the outside due to a certain accident or circumstances, it is desirable to change in units of a fixed amount of controller, for example, for each production lot.

Note that, in the key generator 3002 and the device key database 3001, not only the media device key Kmd_i and the media device key certificate Certmedia for the memory card 1000 but also a host device key Khd_j and a host device key certificate Certhost for the host device 2000 which will be described later are also similarly generated and managed.

The memory card manufacturer H receives the supply of the controller 200 from the controller manufacturer A, and receives the media device key encrypted for the controller 200 (encrypted media device key Enc(Kc, Kmd_i)) and the media device key certificate Certmedia corresponding to the media device key from the key issuance and management center 3000. In order to receive the desired encrypted media device key Enc(Kc, Kind_i), for example, it is possible to receive the media device key encrypted by the correct controller key Kc by presenting a model number, a manufacturing lot number, or the like of the controller 200.

The encrypted media device key Enc(Kc, Kmd_i) is temporarily written to the buffer RAM 203 of the controller 200. The controller 200 decrypts the encrypted media device key Enc(Kc, Kmd_i) written to the buffer RAM 203 in the decryption unit 206 using the controller key Kc included in the controller 200. Therefore, the media device key Kmd_i is obtained in the controller 200.

On the other hand, the unidirectional converter 211 calculates a unidirectional function using the controller key Kc and the controller unique ID (1Dcu) stored in the controller 200 as input values, and generates the controller unique key Kcu. The controller 200 encrypts the media device key Kmd_i again in the encryption unit 207 using the newly generated controller unique key Kcu, and generates an encrypted media device key Enc(Kcu, Kmd_i). The encrypted media device key Enc(Kcu, Kmd_i) is stored in the system information recording section 103 of the memory 100 supplied from the memory manufacturer B. A media device key certificate Certmedia corresponding to the encrypted media device key Enc(Kcu, Kmd_i) written at this time is similarly stored in the system information recording section 103.

The controller unique key (Kcu) is generated using the controller key Kc and the controller unique ID (IDcu) concealed in the controller 200. Therefore, there is little risk that information necessary for decryption of the encrypted media device key Enc(Kcu, Kind_i) leaks to the outside. In addition, it is extremely difficult to illegally encrypt the media device key Kind_i again (encryption by another controller unique key Kcu2 after decryption by an original controller unique key Kcu1) to cause the encrypted media device key Enc(Kcu, Kmd_i) once written in the memory 100 to be able to be used by the separate controller 200.

Note that, in this embodiment, the unidirectional function is used when generating the controller unique key Kcu from the controller key Kc and the controller unique ID (IDcu), but a function that is able to generate one piece of output data from two pieces of input data may be used, and the function is not particularly limited to a unidirectional function.

<5. Writing Content Data to Memory Card>

As described above, the memory card 1000 to which the encrypted media device key Enc(Kcu, Kmd_i) and the media device key certificate Certmedia are given is connected to the host device 2000, and thus the memory card 1000 is able to write the content data C from the host device 2000 or output the content data C recorded in the memory 100 to the host device 2000. Here, first, the operation of writing the content data C to the memory card 1000 will be described.

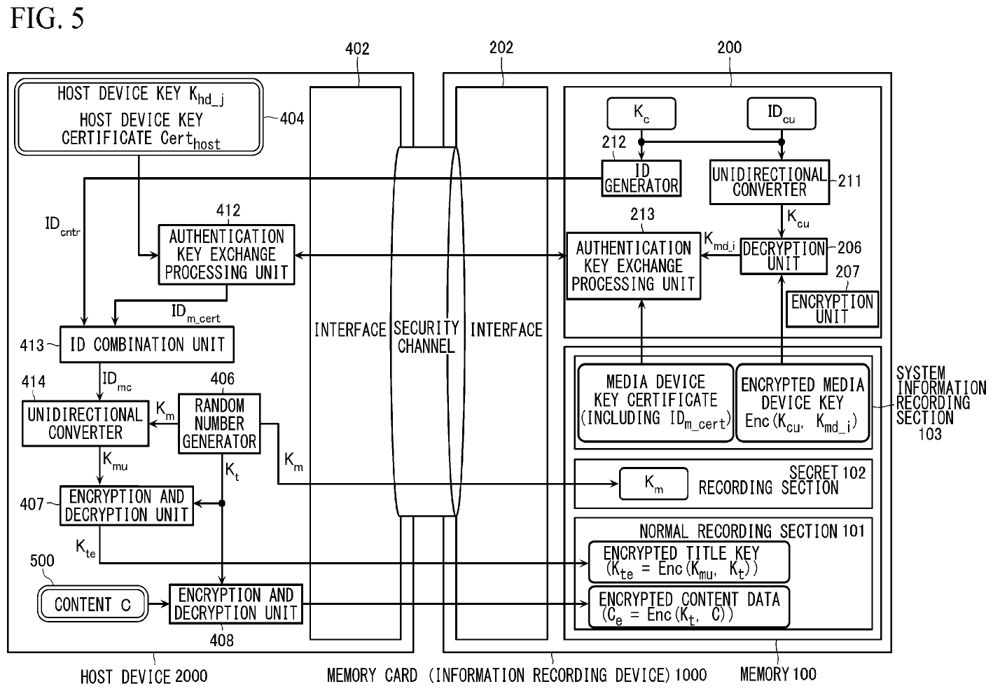

FIG. 5 is a block diagram for describing the operation of writing the content data C to the memory card 1000. In the present embodiment, one information recording system is constituted by the memory card 1000 and the host device 2000.

First, the memory card 1000 generates the controller unique key Kcu from the controller key Kc and the controller unique ID (IDcu) using the unidirectional converter 211. Next, using the generated controller unique key Kcu, the memory card 1000 decrypts the encrypted media device key Enc(Kcu, Kmd_i) recorded in the system information recording section 103 in the decryption unit 206 to obtain the media device key Kmd_i. The decrypted media device key Kmd_i and the media device key certificate Certmedia arc transmitted to the authentication key exchange processing unit 213.

On the other hand, the host device 2000 transmits the host device key Khd_j and the host device key certificate Certhost to the authentication key exchange processing unit 412. Therefore, the authentication key exchange process is executed by the authentication key exchange processing units 213 and 412. In a case where the authentication key exchange process is completed, the secure channel is established between the memory card 1000 and the host device 2000. In a case where the secure channel is established, the ID generator 212 of the memory card 1000 is able to output the public controller unique ID (IDcntr) generated by the ID generator 212 via the interface unit 202 through the secure channel.

In addition, in a case where the secure channel is established, the ID combination unit 413 of the host device 2000 combines the public controller unique ID (IDcntr) received from the memory card 1000 through the secure channel with the media device key certification ID (IDm_cert) included in the media device key certificate Certmedia to generate the memory card unique ID (IDmc).

The host device 2000 generates a media key (Kin) by the random number generator 406, and records the generated media key Km in the secret recording section 102 of the memory card 1000 through the secure channel and the interface units 402 and 202.

The host device 2000 generates the media unique key Kmu from the media key Km and the memory card unique ID (IDmc) using the unidirectional converter 414.

The host device 2000 generates the title key Kt using the random number generator 406, further encrypts the title key Kt by the media unique key Kmu using the encryption and decryption unit 407, and generates the encrypted title key Kte=Enc(Kmu, Kt). The host device 2000 records the generated encrypted title key Kte=Enc(Kmu, Kt) in the normal recording section 101 of the memory card 1000. In addition, the host device 2000 encrypts the content data C in the encryption and decryption unit 408 using the title key Kt, and generates encrypted content data Ce=Enc(Kt, C). The host device 2000 records the generated encrypted content data Ce in the normal recording section 101 of the memory card 1000. Therefore, the recording operation of the content data C is completed.

<6. Reading Content Data from Memory Card>

Next, an operation of reading the content data C from the memory card 1000 will be described. In this read operation, the authentication key exchange process by the authentication key exchange processing units 213 and 412 and the operation in the ID combination unit 413 are substantially the same as in a case of the write operation (FIG. 5).

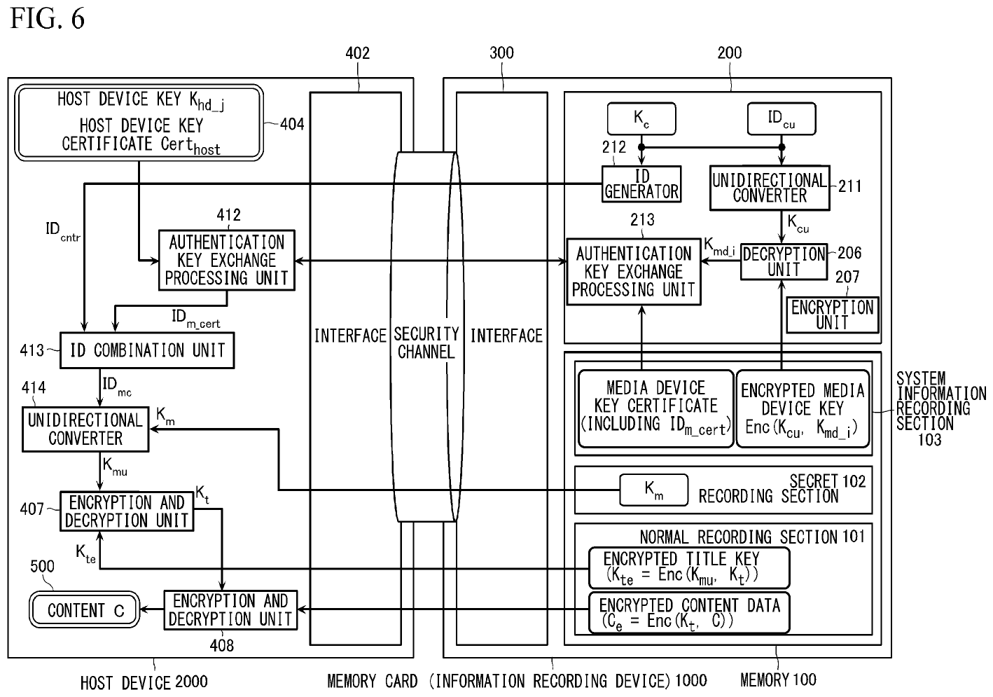

FIG. 6 is a block diagram for describing the operation of reading the content data C from memory card 1000. In a case where the authentication key exchange process is completed and the secure channel is established, access to the secret recording section 102 and the system information recording section 103 of the memory card 1000 becomes possible (that is, designation of the logical address of the secret recording section 102 and the system information recording section 103 becomes possible).

In addition, in a case where the memory card 1000 receives the read command of the encrypted content data Ce from the host device 2000, the memory card 1000 reads the designated encrypted content data Ce and the encrypted title key Kte corresponding to the designated encrypted content data Ce from the normal recording section 101, and transmits the designated encrypted content data Ce and the encrypted title key Kte to the host device 2000. In addition, the memory card 1000 reads the media key Km corresponding to the designated encrypted content data Cc from the secret recording section 102, and transmits the media key Km to the host device 2000 through the secure channel. The media key Kin transmitted from the memory card 1000 to the host device 2000 is provided to the unidirectional converter 414 of the host device 2000.

The unidirectional converter 414 generates the media unique key Kmu using the provided media key Km and the above-described memory card unique ID (IDmc). The encryption and decryption unit 407 decrypts the encrypted title key Kte received from the memory card 1000 using the media unique key Kmu to obtain the title key Kt. In addition, the host device 2000 decrypts the encrypted content data Ce received from the memory card 1000 using the obtained title key Kt to obtain the content data C.

<7. Area Division of Secret Recording Section and Process According to Area Division>

Next, a constitution that contributes to further improvement of the security level of the information recording device 1000 and the host device 2000 will be described.

<7.1 Regarding Area Setting in Secret Recording Section>

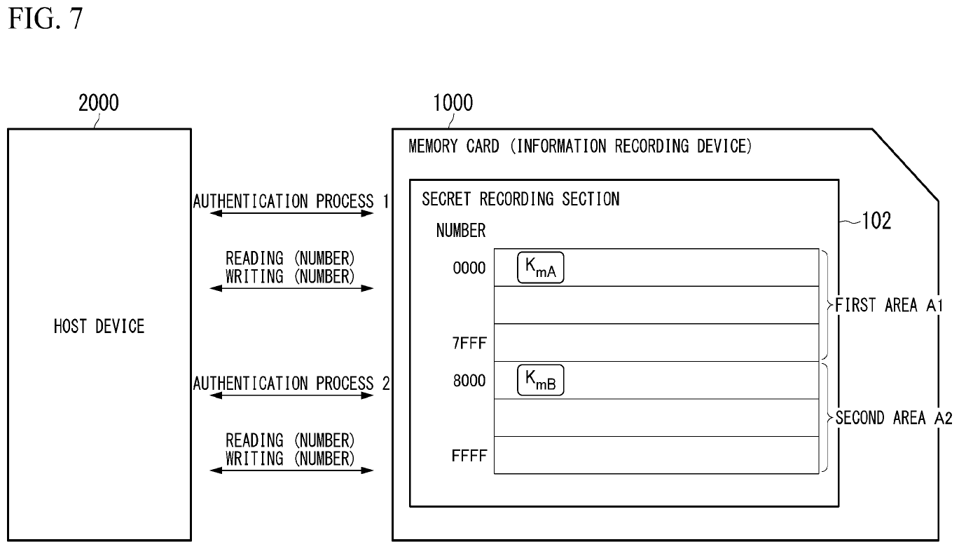

FIG. 7 is a diagram showing the area setting of the secret recording section 102. In the present embodiment, the secret recording section 102 is divided into a first area A1 and a second area A2. The first area A1 is an area where access is possible in a case where a first authentication process (described later) that is one of the authentication key exchange processes is completed. On the other hand, the second area A2 is an area where access is possible in a case where a second authentication process (described later) that is another one of the authentication key exchange processes is completed. In the shown example, addresses (numbers) of “0000” to “FFFF” are given to the secret recording section 102 in hexadecimal number as logical addresses, an area of logical addresses “0000” to “7FFF” is set as the first area A1 in the secret recording section 102, and an area of logical addresses of “8000” to “FFFF” is set as the second area A2 in the secret recording section 102. However, the division between the first area A1 and the second area A2 is not limited to the example described above, and the first area A1 may be larger than the second area A2, and the second area A2 may be larger than the first area A1.

In the present specification, “set the area” means, for example, for each logical address of the secret recording section 102 in an access condition management table T (described later) to which the controller 200 corresponding to an access right of the secret recording section 102 refers, the condition that the logical address is able to be designated is set. That is, the first area A1 and the second area A2 are divided by setting, on management information, an area where access of the host device 2000 is permitted in a case where the first authentication process is performed and an area where the access of the host device 2000 is permitted in a case where the second authentication process is performed. The access condition management table T is an example of the “management information”. In the present embodiment, the secret recording section 102 is one area in which the logical addresses are continuous over the first area A1 and the second area A2.

In the present embodiment, in a case where the content data C of the first standard (for example, moving image data conforming to the standard of high vision broadcast) is recorded in the normal recording section 101 of the memory 100, the first media key KmA that is the media key Km related to the encryption of the recorded content data C of the first standard is stored in the first area A1. The first media key KmA is key information used for decrypting the encrypted content data C of the first standard, and is an example of the “first key information”. In addition, copy restriction information indicating an upper limit value of the number of copies of the content data C of the first standard, and the like arc also recorded in the first area A1. Each of the first media key KmA and the copy restriction information is an example of the information related to the content data C of the first standard.

On the other hand, in a case where the content data C of the second standard (for example, moving image data conforming to the standard of 4K broadcast) is recorded in the normal recording section 101 of the memory 100, the second media key KmB that is the media key Km related to the encryption of the recorded content data C of the second standard is stored in the second area A2. The second media key KmB is key information used for decrypting the encrypted content data C of the second standard, and is an example of the “second key information”. In addition, copy restriction information indicating an upper limit value of the number of copies of the content data C of the second standard, and the like are also recorded in the second area A2. Each of the second media key KmB and the copy restriction information is an example of the information related to the content data C of the second standard.

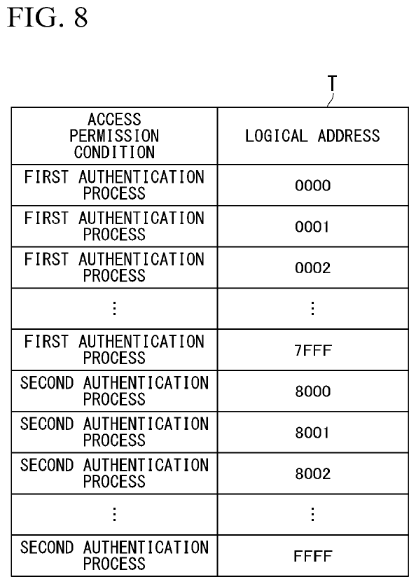

FIG. 8 is a diagram showing the access condition management table T. In the access condition management table T, access conditions for each logical address of the secret recording section 102 are set. In the present embodiment, the completion of the first authentication process is set as the access condition with respect to the logical addresses “0000” to “7FFF”. On the other hand, the completion of the second authentication process is set as the access condition with respect to the logical addresses “8000” to “FFFF”. The access condition management table T is stored, for example, in the memory 100, read by the controller 200 to the buffer RAM 203, and used. The access condition management table T is recorded, for example, in the system information recording section 103 of the memory 100. According to such a constitution, falsification of the access condition management table T becomes more difficult. In addition, a capacity ratio between the first area A1 and the second area A2 is able to be arbitrarily set by adjusting contents of the access condition management table T recorded in the memory 100.

<7.2 Regarding First Authentication Process and Second Authentication Process>

Next, the first authentication process and the second authentication process will he described. First, the first authentication process will be described. The first authentication process is an authentication key exchange process that is required in a case where the content data C of the first standard is written to the memory card 1000 and in a case where the content data C of the first standard written to the memory card 1000 is read.

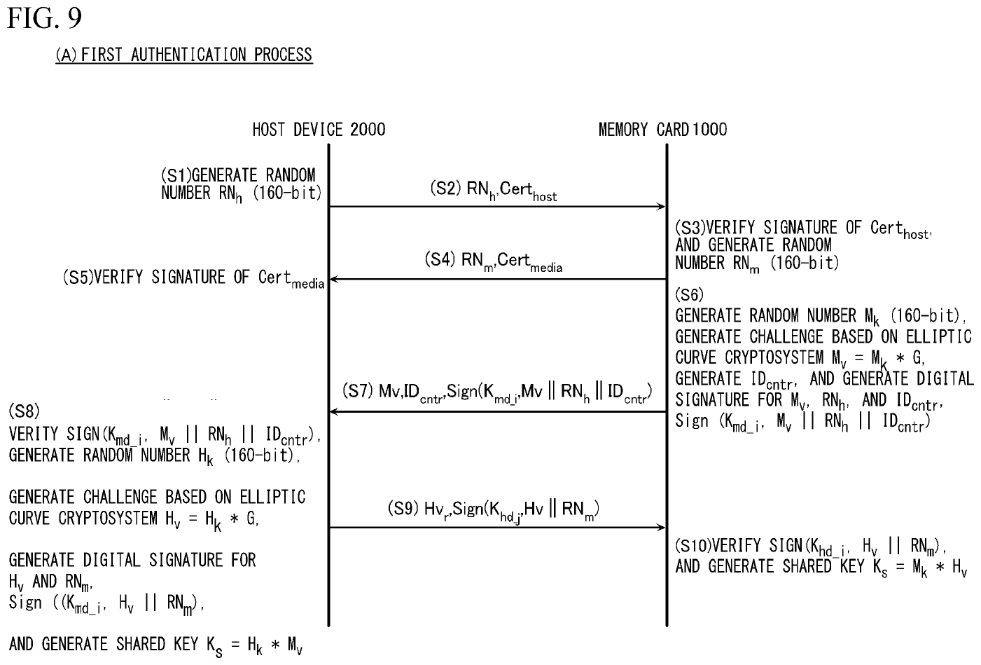

FIG. 9 is a flow chart showing an operation of the first authentication process. In the present embodiment, the first authentication process is performed by an authentication key exchange based on elliptic curve cryptosystem. First, the host device 2000 generates a random number RNh (step S1), and transmits the generated random number RNh and the host device key certificate Certhost to the memory card 1000 (step S2). The memory card 1000 verifies the digital signature attached to the received host device key certificate Certhost, and generates a random number RNm (step S3).

Subsequently, the memory card 1000 transmits the generated random number RNm and the media device key certificate Certmedia to the host device 2000 (step S4). In response to this, the host device 2000 verifies the digital signature attached to the received media device key certificate Certmedia (step S5).

The memory card 1000 performs the process of step S4 and generates a random number Mk necessary for a Diffie-Hellman key exchange process in the elliptic curve cryptosystem, and calculates a challenge value Mv (=Mk*G) by using a base point G of an elliptic curve. In addition, the memory card 1000 generates the IDcntr by the ID generator 212, and generates a digital signature for the challenge value Mv, the random number RNh received in step S2, and the controller unique ID (IDcntr) using the media device key Kmd_i. (step S6). The memory card 1000 transmits the challenge value Mv generated in step S6, the controller unique ID (IDcntr) read from the fuse circuit 208, and the digital signature generated in step S6 to the host device 2000 (step S7).

The host device 2000 verifies the digital signature received in step S7, generates a random number Hk necessary for a Diffie-Hellman key exchange process in the elliptic curve cryptosystem, and calculates a challenge value Hv (=Hk*G) by using the base point G of the elliptic curve. In addition, the host device 2000 generates a digital signature for the challenge value Hv and the random number RNm received in step S4 using the host device key Khd_j, and calculates a shared key Ks (=Hk*Mv) shared by the authentication key exchange process (step S8). The host device 2000 transmits the challenge value Hv generated in step S8 and the digital signature to the memory card 1000 (step S9). In response to this, the memory card 1000 verifies the digital signature received in step S9, and calculates a shared key Ks (=Mk*Hv). In a case where the digital signature is not able to be correctly verified in the digital signature verification process of the process described above, the subsequent process is stopped in any step.

By performing the authentication key exchange process described above, the host device 2000 and the memory card 1000 are able to secretly share the shared key Ks. Since the shared key Ks is calculated using the challenges generated by the host device 2000 and the memory card 1000 in the authentication key exchange process, a value of the shared key Ks is different every authentication key exchange process. Each of the host device key certificate Certhost and the media device key certificate Certmedia is an example of the “certificate information”.

In the present embodiment, in the first authentication process described above, each of the random number RNh generated in step S1, the random number RNm generated in step S3, the random number Mk generated in step S6, and the random number Hk generated in step S8 is a random number of 160 bits. In other words, each of the random number RNh, the random number RNm, the random number Mk, and the random number Hk used in the first authentication process is information having a first length as a data length.

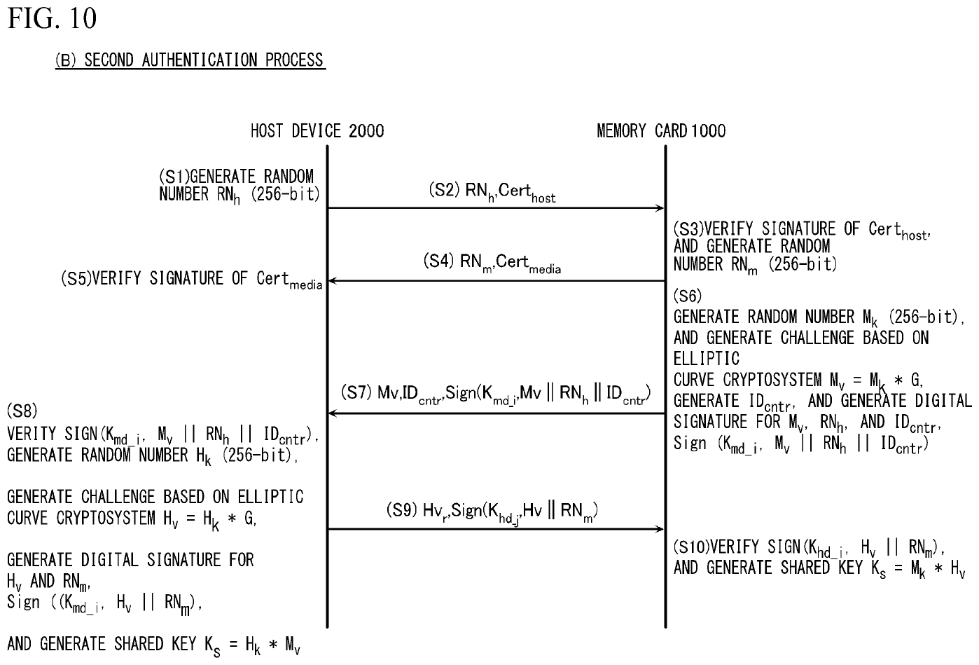

Next, the second authentication process will be described. FIG. 10 is a flowchart showing an operation of the second authentication process. The second authentication process is an authentication key exchange process that is required in a case where the content data C of the second standard is written to the memory card 1000 and in a case where the content data C of the second standard written to the memory card 1000 is read. The operation of the second key authentication process (for example, the operation of steps S1 to S10) is the same as the operation of the first authentication process (for example, the operation of steps S1 to S10) except for the lengths of random number RNh, the random number RNm, the random number Mk, and the random number Hk.

In the second authentication process, since a key length is longer than that in the first authentication process, a random number having a length of 256 bits is used as each of the random number RNh, the random number RNm, the random number Mk, and the random number Hk. In other words, each of the random number RNh, the random number RNm, the random number Mk, and the random number Hk used in the second authentication process is information having a second length longer than the first length as a data length. The second authentication process is an example of an authentication process having a security level higher than that of the first authentication process. However, the first authentication process and the second authentication process are not limited to the example described above. The second authentication process may be an authentication process having a security level higher than that of the first authentication process in a point different from the length of the random number.

<7.3 Host Device Key Certificate>

Next, the host device key certificate Certhost will be described.

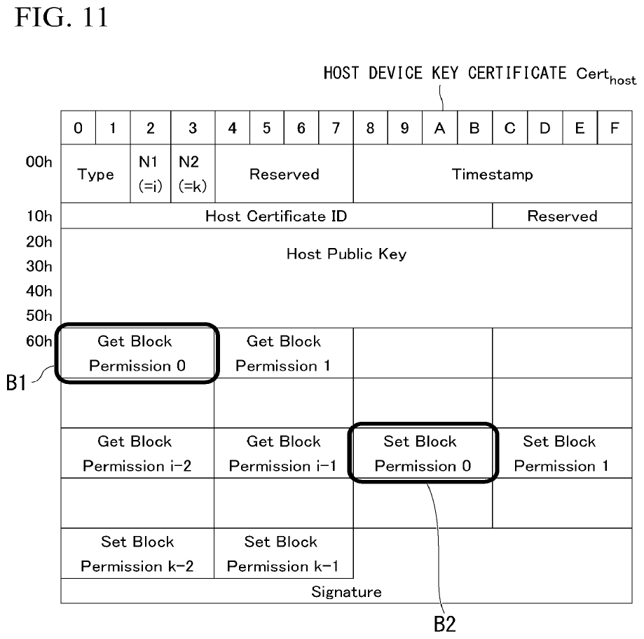

FIG. 11 is a diagram showing the host device key certificate Certhost used in the second authentication process. Note that the host device key certificate Certhost used in the first authentication process is also similar to contents shown in FIG. 11.

A logical address in the secret recording section 102 that is able to be accessed by the host device 2000 after the authentication key exchange process is completed is described in the host device key certificate Certhost. More specifically, logical addresses (refer to a thick line B2 in the figure, for example) in the secret recording section 102 where the host device 2000 is able to write data after the authentication key exchange process is completed, and logical addresses (refer to a thick line B1 in the figure, for example) in the secret recording section 102 where the host device 2000 is able to read data after the authentication key exchange process is completed are described in the host device key certificate Certhost. Note that the description of the logical addresses is different between the host device key certificate Certhost used in the first authentication process and the host device key certificate Certhost used in the second authentication process. For example, the logical addresses in the first area A1 of the secret recording section 102 are described in the legitimate host device key certificate Certhost used for the first authentication process. On the other hand, the logical addresses in the second area A2 of the secret recording section 102 are described in the legitimate host device key certificate Certhost used in the second authentication process.

Here, regarding an access restriction to the secret recording section 102, the controller 200 of the memory card 1000 of the present embodiment gives priority to the access condition management table T over the host device key certificate Certhost used in the authentication key exchange process and applies the access condition management table T. That is, even in a case where a specific logical address of the secret recording section 102 is described in the host device key certificate Certhost as an accessible logical address, in a case where the access to the specific logical address is restricted in the access condition management table T, the controller 200 does not permit the assess of the logical address. The host device key certificate Certhost is an example of “first information”.

### <7.4 Access Restriction by Controller>

Next, the access restriction by the controller 200 will be described.

The controller 200 of the present embodiment permits access (writing and reading of information) to the first area A1 of the secret recording section 102 only in a case where the first authentication process is performed. In the present embodiment, even in a case where the second authentication process is performed, the controller 200 does not permit the access to the first area A1 of the secret recording section 102 in a case where the first authentication process is not performed.

On the other hand, the controller 200 permits access to the second area A2 of the secret recording section 102 only in a case where the second authentication process is performed. Even in a case where the first authentication process is performed, the controller 200 does not permit the access to the second area A2 of the secret recording section 102 in a case where the second authentication process is not performed.

Hereinafter, these details will be described. Note that, here, a case in which the content data C of the second standard is written and read will be described as a representative. Regarding the case in which the content data C of the first standard is written and read, in the following description, the “second standard” may be read as the “first standard”, the “second authentication process” may be read as the “first authentication process”, the “second area” may be read as the “first area”, and the “second media key KmB” may be read as the “first media key KmA”.

<7.4.1 In Case in Which Content Data of Second Standard is Written>

First, the case in which the content data of the second standard is written will be described.

In the present embodiment, in a case where the host device 2000 writes the content data C of the second standard to the memory card 1000, the authentication key exchange processing unit 412 of the host device 2000 performs the second authentication process described above with the authentication key exchange processing unit 213 of the memory card 1000.

In addition, after completion of the second authentication process, the controller 400 of the host device 2000 generates the second media key KmB corresponding to the content data C of the second standard to be written, and writes the generated second media key KmB to the secret recording sections 102 of the memory card 1000. That is, the controller 400 of the host device 2000 transmits a write command designating the logical address in the second area A2 of the secret recording section 102 to the memory card 1000.

In a case where the controller 200 of the memory card 1000 receives the write command designating the logical address in the second area A2 of the secret recording section 102 from the host device 2000 after the second authentication process, the controller 200 of the memory card 1000 executes a process (for example, a process of writing the second media key KmB to the second area A2 of the secret recording section 102) based on the write command. In a case where the process of writing the second media key KmB to the second area A2 of the secret recording section 102 is normally executed, the controller 400 of the host device 2000 encrypts the content data C of the second standard to be written, and transmits the encrypted title key Kte and the encrypted content data Ce to the memory card 1000. Therefore, the encrypted title key Kte and the encrypted content data Ce are recorded in the normal recording section 101 of the memory card 1000.

On the other hand, in a case where the controller 200 receives the write command designating the logical address in the second area A2 of the secret recording section 102 from the host device 2000 without performing the second authentication process, the controller 200 transmits error information to the host device 2000 without performing the process based on the write command For example, even in a case where the first authentication process is normally completed, the controller 200 does not execute the process based on the command for the second area A2 of the secret recording section 102 in a case where the second authentication process is not performed. In the present embodiment, in a case where the second authentication process is not performed, the controller 200 does not execute the process for the second area A2 of the secret recording section 102, and transmits error information to the host device 2000, even in a case where the first authentication process is normally performed and the logical address in the second area A2 is described as the accessible logical address in the host device key certificate Certhost used in the first authentication process. In this case, the second media key KmB is not written to the second area A2 of the secret recording section 102. In addition, the encrypted title key Kte and the encrypted content data Ce are not recorded in the normal recording section 101 of the memory card 1000.

<7.4.2 In Case in Which Content Data of Second Standard is Read>

Next, the case in which the content data of the second standard is read will be described.

In the present embodiment, in a case where the host device 2000 reads the content data C of the second standard from the memory card 1000, the second authentication key exchange processing unit 412 of the host device 2000 performs the second authentication process described above with the authentication key exchange processing unit 213 of the memory card 1000.

In addition, after the completion of the second authentication process, the controller 400 of the host device 2000 reads the second media key KmB corresponding to the content data C of the second standard to be read from the secret recording section 102 of the memory card 1000. That is, the controller 400 of the host device 2000 transmits a read command designating the logical address in the second area A2 of the secret recording section 102 in which the second media key Kmb is recorded to the memory card 1000.

In a case where the controller 200 of the memory card 1000 receives the read command designating the logical address in the second area A2 of the secret recording section 102 from the host device 2000 after the second authentication process, the controller 200 of the memory card 1000 executes a process (for example, a process of reading the second media key KmB from the second area A2 of the secret recording section 102) based on the read command. In a case where the process of reading the second media key KmB from the second area A2 of the secret recording section 102 is normally executed, the controller 400 of the host device 2000 reads the encrypted title key Kte and the encrypted content data Ce corresponding to the content data C of the second standard to be read from the normal recording section 101 of the memory card 1000.

On the other hand, in a case where the controller 200 receives the read command designating the logical address in the second area A2 of the secret recording section 102 from the host device 2000 without performing the second authentication process, the controller 200 transmits error information to the host device 2000 without performing the process based on the read command. For example, even in a case where the first authentication process is normally completed, the controller 200 does not execute the process based on the command for the second area A2 of the secret recording section 102 in a case where the second authentication process is not performed. In the present embodiment, in a case where the second authentication process is not performed, the controller 200 does not execute the process for the second area A2 of the secret recording section 102, and transmits error information to the host device 2000, even in a case where the first authentication process is normally performed and the logical address in the second area A2 where the second media key KmB is recorded is described as the logical address accessible by the host device 2000 indicated by the host device key certificate Certhost used in the first authentication process. In this case, the second media key KmB is not read from the second area A2 of the secret recording section 102. In addition, the encrypted title key Kte and the encrypted content data Ce are not read from the normal recording section 101 of the memory card 1000.

<7.5 Flow of Process of Host Device and Memory Card>

<7.5.1 Process of Host Device in Case in Which Content Data is Recorded>

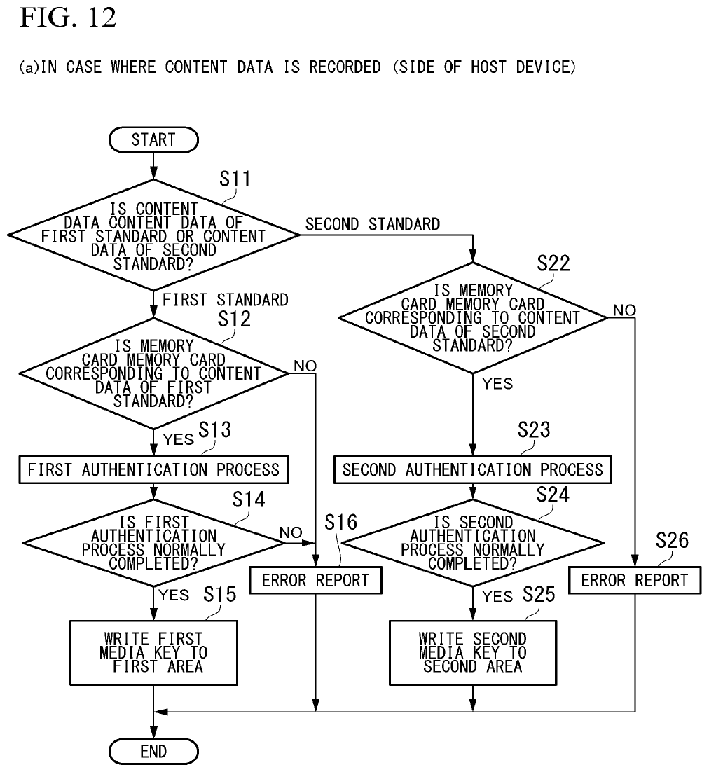

FIG. 12 shows the flow of the process of the host device 2000 in a case where the content data C is recorded in the memory card 1000. First, the content type determination unit 410 of the host device 2000 determines whether the content data C to be written is the content data C of the first standard or the content data C of the second standard (step S11).

Next, in a case where it is determined that the content data C to be written is the content data C of the first standard (step S11: first standard), the content type determination unit 411 of the host device 2000 transmits a predetermined first command to the memory card 1000, and determines whether or not the memory card 1000 is the information recording device corresponding to the content data C of the first standard on the basis of a response result to the first command (step S12).

Next, in a case where it is determined that the memory card 1000 is the information recording device corresponding to the content data C of the first standard (step S12: YES), the authentication key exchange processing unit 412 of the host device 2000 executes the first authentication process (step S13). In addition, the authentication key exchange processing unit 412 of the host device 2000 determines whether or not the first authentication process is normally completed (step S14).

In a case where the first authentication process is normally completed (step S14: YES), the controller 400 of the host device 2000 generates the first media key KmA by the random number generator 406, and transmits the first media key KmA to the memory card 1000 together with the write command designating the logical address in the first area A1 of the secret recording section 102 of the memory card 1000 (step S15). Therefore, the first media key KmA is recorded in the memory card 1000.

In addition, although not shown, in a case where the first authentication process is normally completed (step S14: YES), the controller 400 of the host device 2000 encrypts the title key Kt and the content data C to be written, and generates the encrypted title key Kte and the encrypted content data Ce. In addition, the controller 400 of the host device 2000 transmits the generated encrypted title key Kte and encrypted content data Ce to the memory card 1000 together with the write command designating the logical address in the normal recording section 101 of the memory card 1000. Therefore, the encrypted title key Kte and the encrypted content data Ce are recorded in the memory card 1000.

In a case where it is determined that the memory card 1000 is not the information recording device corresponding to the content data C of the first standard (step S12: NO), or in a case where the first authentication process is not normally completed (step S14: NO), the controller 400 of the host device 2000 performs a process of displaying the error information on a display screen of the host device 2000, a display screen of a device connected to the host device 2000, or the like (step S16). In this case, the encrypted title key Kte and the encrypted content data Ce are not transmitted to the memory card 1000.

On the other hand, in a case where it is determined that the content data C to be written is the content data C of the second standard (step S11: second standard), the content type determination unit 411 of the host device 2000 transmits a predetermined second command to the memory card 1000, and determines whether or not the memory card 1000 is the information recording device corresponding to the content data C of the second standard on the basis of a response result to the second command (step S22).

Next, in a case where it is determined that the memory card 1000 is the information recording device corresponding to the content data C of the second standard (step S22: YES), the authentication key exchange processing unit 412 of the host device 2000 executes the second authentication process (step S23). In addition, the authentication key exchange processing unit 412 of the host device 2000 determines whether or not the second authentication process is normally completed (step S24).

In a case where the second authentication process is normally completed (step S24: YES), the controller 400 of the host device 2000 generates the second media key KmB by the random number generator 406, and transmits the second media key KmB to the memory card 1000 together with the write command designating the logical address in the second area A2 of the secret recording section 102 of the memory card 1000 (step S25). Therefore, the second media key KmB is recorded in the memory card 1000. In addition, although not shown, in a case where the second authentication process is normally completed (step S24: YES), the controller 400 of the host device 2000 encrypts the title key Kt and the content data C to be written, and generates the encrypted title key Kte and the encrypted content data Ce. In addition, the controller 400 of the host device 2000 transmits the generated encrypted title key Kte and encrypted content data Ce to the memory card 1000 together with the write command designating the logical address in the normal recording section 101 of the memory card 1000. Therefore, the encrypted title key Kte and the encrypted content data Ce are recorded in the memory card 1000.

In a case where it is determined that the memory card 1000 is not the information recording device corresponding to the content data C of the second standard (step S22: NO), or in a case where the second authentication process is not normally completed (step S24: NO), the controller 400 of the host device 2000 performs a process of displaying the error information on a display screen of the host device 2000, a display screen of a device connected to the host device 2000, or the like (step S26). In this case, the encrypted title key Kte and the encrypted content data Ce are not transmitted to the memory card 1000.

<7.5.2 Process of Memory Card in Case in Which Content Data is Recorded>

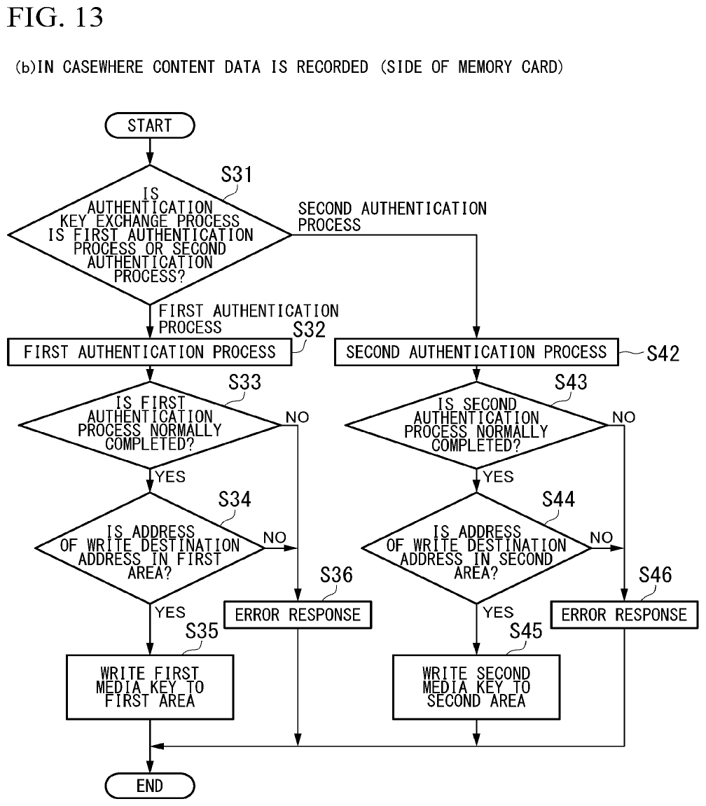

FIG. 13 shows the flow of the process of the memory card 1000 in a case where the content data C is recorded in the memory card 1000. In a case where the authentication key exchange process is started between the host device 2000 and the memory card 1000, the controller 200 of the memory card 1000 determines whether the authentication key exchange process to be started is the first authentication process or the second authentication process on the basis of the information transmitted from the host device 2000 (for example, on the basis of the length of the random number RNh of the authentication key exchange process, which is initially transmitted) (step S31).

In a case where it is determined that the first authentication process is to be started (step S31: first authentication process), the authentication key exchange processing unit 213 of the memory card 1000 performs the first authentication process with the authentication key exchange processing unit 412 of the host device 2000 (step S32). In addition, the authentication key exchange processing unit 213 of the memory card 1000 determines whether or not the first authentication process is normally completed (step S33).

Next, in a case where the first authentication process is normally completed (step S33: YES), and in a case where the recording control unit 214 of the memory card 1000 receives the write command and the first media key KmA from the host device 2000, the recording control unit 214 of the memory card 1000 determines whether or not the logical address designated by the write command is the logical address in the first area A1 of the secret recording section 102 (step S34). Specifically, the recording control unit 214 of the memory card 1000 refers to the access condition management table T and determines whether or not the logical address designated by the write command is a logical address to which access is permitted by the first authentication process.

In a case where the logical address designated by the write command is the logical address in the first area A1 of the secret recording section 102 (step S34: YES), the recording control unit 214 of the memory card 1000 writes the first media key KmA received from the host device 2000 to the first area A1 of the secret recording section 102 (step S35).

In addition, although not shown, in a case where the logical address designated by the write command is the logical address in the first area A1 of the secret recording section 102 (step S34: YES), the recording control unit 214 of the memory card 1000 writes the encrypted title key Kte and the encrypted content data Ce separately received from host device 2000 to the normal recording section 101 of the memory card 1000.

In a case where the first authentication process is not normally completed (step S33: NO), or in a case where the logical address designated by the write command after the first authentication process is not the logical address in the first area A1 of the secret recording section 102 (step S34: NO), the controller 200 of the memory card 1000 performs an error response with respect to the host device 2000 (step S36).

On the other hand, in a case where it is determined that the second authentication process is to be started (step S31: second authentication process), the authentication key exchange processing unit 213 of the memory card 1000 performs the second authentication process with the authentication key exchange processing unit 412 of the host device 2000 (step S42). In addition, the authentication key exchange processing unit 213 of the memory card 1000 determines whether or not the second authentication process is normally completed (step S43).

Next, in a case where the second authentication process is normally completed (step S43: YES), and in a case where the recording control unit 214 of the memory card 1000 receives the write command and the second media key KmB from the host device 2000, the recording control unit 214 of the memory card 1000 determines whether or not the logical address designated by the write command is the logical address in the second area A2 of the secret recording section 102 (step S44). Specifically, the recording control unit 214 of the memory card 1000 refers to the access condition management table T and determines whether or not the logical address designated by the write command is a logical address to which access is permitted by the second authentication process.

In a case where the logical address designated by the write command is the logical address in the second area A2 of the secret recording section 102 (step S44: YES), the recording control unit 214 of the memory card 1000 writes the second media key KmB received from the host device 2000 to the second area A2 of the secret recording section 102 (step S45).

In addition, although not shown, in a case where the logical address designated by the write command is the logical address in the second area A2 of the secret recording section 102 (step S44: YES), the recording control unit 214 of the memory card 1000 writes the encrypted title key Kte and the encrypted content data Ce separately received from host device 2000 to the normal recording section 101 of the memory card 1000.

In a case where the second authentication process is not normally completed (step S43: NO), or in a case where the logical address designated by the write command after the second authentication process is not the logical address in the second area A2 of the secret recording section 102 (step S44: NO), the controller 200 of the memory card 1000 performs an error response with respect to the host device 2000 (step S46).

The flow of the process of the host device 2000 and the memory card 1000 in the case in which the content data C is recorded in the memory card 1000 has been described above. Note that, regarding the flow of the process of the host device 2000 in the case in which the content data C recorded in the memory card 1000 is read, in the above described with reference to FIG. 12, the “content data C to be written” may be read as the “content data C to be read”, “transmit the generated first media key KmA to the memory card 1000 together with the write command designating the logical address in the first area A1 of the secret recording section 102 of the memory card 1000” may be read as “transmit the read command designating the logical address in the first area A1 of the secret recording section 102 of the memory card 1000, and read the first media key KmA from the first area A1 of the secret recording section 102”, and “transmit the encrypted title key Kte and the encrypted content data Ce to the memory card 1000” may be read as “read the encrypted title key Kte and the encrypted content data Ce from the memory card 1000”.

In addition, regarding the flow of the process of the memory card 1000 in the case in which the content data C recorded in the memory card 1000 is read, in the above description with reference to FIG. 13, “write” may be read as “read”, the “write command” may be read as the “read command”, “in a case where the write command and the first media key KmA are received from the host device 2000, it is determined whether or not the logical address designated by the write command is the logical address in the first area A1 of the secret recording section 102” may be read as “in a case where the read command of the first media key KmA is received from the host device 2000, it is determined whether or not the logical address designated by the read command is the logical address in the first area A1 of the secret recording section 102”, and “in a case where the write command and the second media key KmB are received from the host device 2000, it is determined whether or not the logical address designated by the write command is the logical address in the second area A2 of the secret recording section 102” may be read as “in a case where the read command of the second media key KmB is received from the host device 2000, it is determined whether or not the logical address designated by the read command is the logical address in the second area A2 of the secret recording section 102”.

<8. Effect of the Embodiment>

For example, it is desirable that the information recording device is able to handle both of an authentication process (first authentication process) performed with a first type host device and an authentication process (second authentication process) performed with a second type host device in order to ensure compatibility and the like. Here, if the area of the secret recording section to which access is permitted in a case where the first authentication process is performed and the area of the secret recording section to which access is permitted in a case where the second authentication process is performed overlap each other, there is a possibility that illegal falsification or reading of information may be performed up to the area where security is secured in the other of the first authentication process and the second authentication process in a case where one of the first authentication process and the second authentication process is used illegally.

Therefore, in the present embodiment, the controller 200 of the memory card 1000 permits the access to the first area A1 of the secret recording section 102 in a case where the first authentication process related to the secret recording section 102 is performed, and permits the access to the second area A2 of the secret recording section 102 in a case where the second authentication process related to the secret recording section 102 is performed. According to such a constitution, even in a case where one of the first authentication process and the second authentication process is illegally used, it is possible to protect information of an area where security is secured in the other of the first authentication process and the second authentication process. Therefore, it is possible to improve the security level of the information recording device.

As an example, it is desirable that the information recording device is able to be connected to both of a host device (old host device) conforming to the existing standard and a host device (new host device) conforming to a new standard of which the security level is improved. Therefore, in the present embodiment, the first authentication process is performed with the old host device, and the second authentication process of which the security level is high is performed with the new host device. In addition, in the information recording device, the area of the secret recording section to which the access is permitted in a case where the first authentication process is performed and the area of the secret recording section to which the access is permitted in a case where the second authentication process is performed are divided. According to such a constitution, even in a case where a technology for decrypting the encryption of the first authentication process appears, it is possible to protect the information of the area where security is secured by the relatively strong second authentication process.

For example, it may be conceivable that in a case where the logical addresses in the secret recording section 102 accessible by the host device 2000 is described in the host device key certificate Certhost used in the first authentication process, the second area A2 of the secret recording section 102 is able to be accessed without performing the second authentication process by falsifying the logical address in the host device key certificate Certhost used in the first authentication process in a case where the encryption of the first authentication process is decrypted.

However, in the present embodiment, in a case where the encryption of the first authentication process is decrypted, the memory card 1000 controller 200 does not permit the access to the second area A2 in a case where the second authentication process is not performed, even in a case where the position in the second area A2 of the secret recording section 102 is included in the host device key certificate Certhost used in the first authentication process. According to such a constitution, even in a case where the host device key certificate Certhost used in the first authentication process is falsified, it is possible to protect the information in the second area A2.

In the present embodiment, even in a case where the second authentication process is performed, the controller 200 of the memory card 1000 does not permit the access to the first area A1 in a case where the first authentication process is not performed. According to such a constitution, a selective use of the first area A1 and the second area A2 becomes clearer, and management becomes easier.

Hereinafter, some modified examples of the first embodiment will be described. Note that, in each modified example, the constitutions other than that described below are the same as those of the first embodiment.

### FIRST MODIFIED EXAMPLE

Next, the memory card 1000 of the modified example of the first embodiment will be described.

As described above, even in a case where the second authentication process is performed, the controller 200 of the memory card 1000 of the first embodiment does not permit the access (writing and reading of information) to the first area A1 of the secret recording section 102 in a case where the first authentication process is not performed.

On the other hand, in a case where the second authentication process is performed, the controller 200 of the memory card 1000 of the present modified example permits the access (writing and reading of information) to the first area A1 of the secret recording section 102 even though the first authentication process is not performed. For example, in a case where the second authentication process is performed, the controller 200 of the memory card 1000 of the present modified example permits writing of the first media key KmA in the first area A1 of the secret recording section 102 and reading of the first media key KmA from the first area A1 even though the first authentication process is not performed.

According to such a constitution, even in a case where the memory card 1000 is connected to the host device 2000 having only the second authentication function, the writing and reading of the content data C of the first standard becomes possible by the host device 2000.

### SECOND MODIFIED EXAMPLE

Next, the host device 2000 of the modified example of the first embodiment will be described.

The host device 2000 of the present modified example is a device that is not able to perform the first authentication process hut is able to perform the second authentication process. Such a host device 2000 is able to be used, for example, in combination with the memory card 1000 of the modified example described above. For example, the host device 2000 of the present modified example performs the second authentication process with the memory card 1000 in any case of a case in which the content data C of the first standard is written to the memory card 1000 and a case in which the content data C of the second standard is written to the memory card 1000.

In addition, in a case where the data to be written is the content data C of the first standard, after the completion of the second authentication process, the host device 2000 transmits the write command designating the logical address of the first area A1 of the secret recording section 102 and writes the first media key KmA to the first area A1 of the secret recording section 102. On the other hand, in a case where the data to be written is the content data C of the second standard, after the completion of the second authentication process, the memory card 1000 transmits the write command designating the logical address of the second area A2 of the secret recording section 102 and writes the second media key KmB to the second area A2 of the secret recording section 102. Note that the same applies to a case in which the content data C written to the memory card 1000 is read. The host device 2000 of the present modified example is able to be used, for example, in combination with the memory card 1000 of the first modified example described above.

### Second Embodiment

Next, a second embodiment will be described. The second embodiment is different from the first embodiment in that a boundary between the first area A1 and the second area A2 of the secret recording section 102 is able to be changed. Note that the constitutions other than that described below are the same as those of the first embodiment.

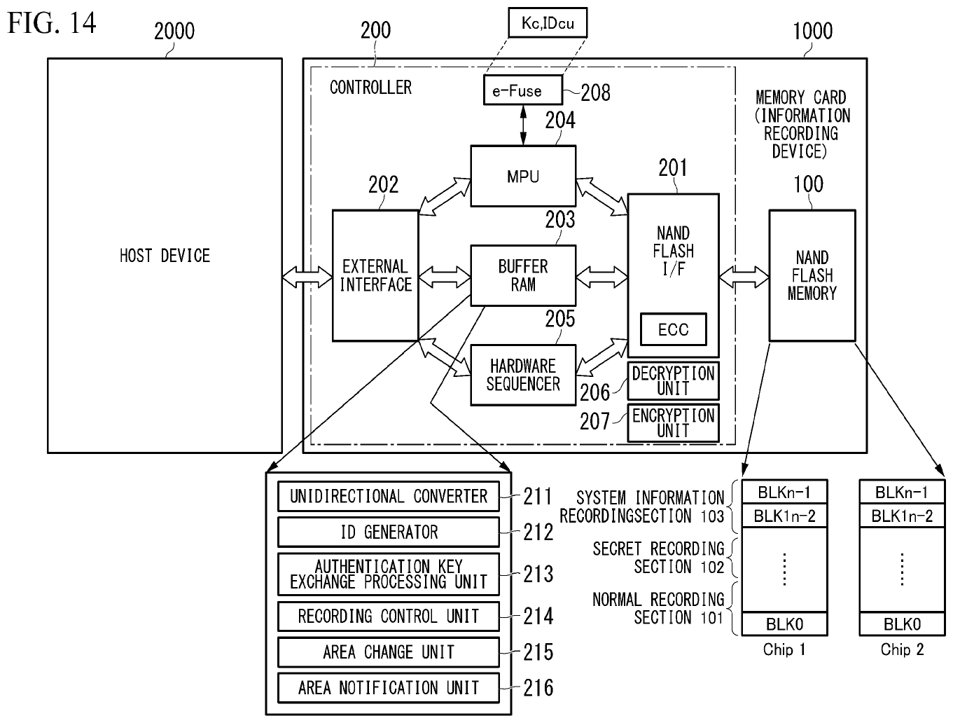

FIG. 14 is a block diagram showing the constitution of the information recording system of the second embodiment. In the present embodiment, the memory card 1000 includes an area change unit 215 and an area notification unit 216. The area change unit 215 monitors an amount of the data written in the first area A1 of the secret recording section 102 and an amount of the data written in the second area A2 of the secret recording section 102, and changes the allocation of the first area A1 and the second area A2 of the secret recording section 102 on the basis of the amounts of data written to each of the first area A1 and the second area A2.

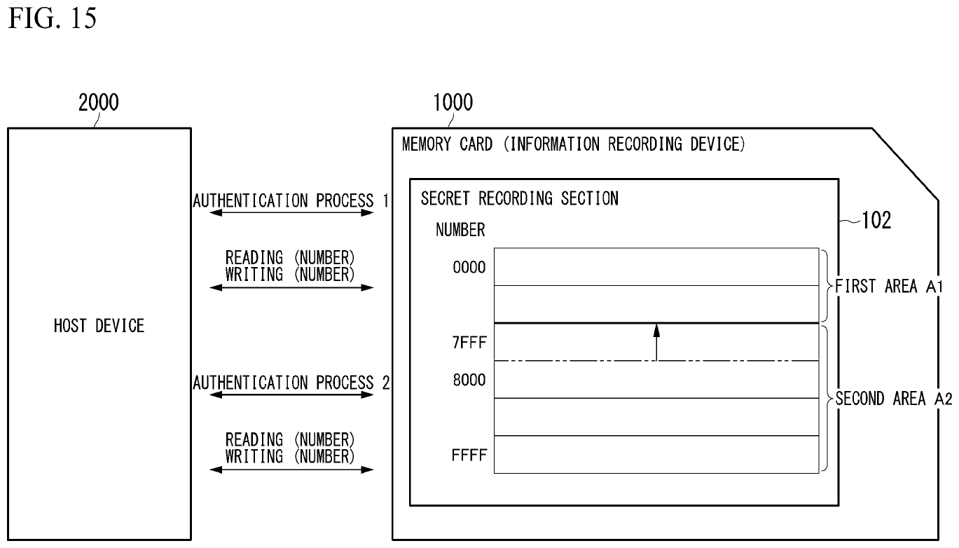

FIG. 15 is a diagram showing an area change of the secret recording section 102 by the area change unit 215.

In a case where a predetermined first condition is satisfied (for example, the amount of the data written to the first region A1 is less than a first value, and the amount of the data written to the second region A2 is equal to or greater than a second value), the area change unit 215 allocates one or more logical addresses allocated to the first area A1 to the second area A2 in the access condition management table T. On the other hand, in a case where a predetermined second condition is satisfied (for example, the amount of the data written to the first region A1 is equal to or greater than the second value, and the amount of the data written to the second region A2 is less than the first value), the area change unit 215 allocates one or more logical addresses allocated to the first area A2 to the second area A1 in the access condition management table T. Therefore, the boundary between the first area A1 and the second area A2 is changed.

The area notification unit 216 transmits, to the host device 2000, information indicating each of the logical addresses of the first area A1 and the second area A2 changed (newly set) by the area change unit 215. The host device 2000 determines the designated logical address on the basis of the information notified from the area notification unit 216.

According to such a constitution, it is possible to more effectively use a storage capacity of the secret recording section 102.

### Third Embodiment

Next, the third embodiment will be described. The present embodiment is different from the first embodiment in that the ID generator 212 transmits the controller unique ID (IDcntr) to the authentication key exchange processing unit 213. Note that the constitutions other than that described below are the same as those of the first embodiment.

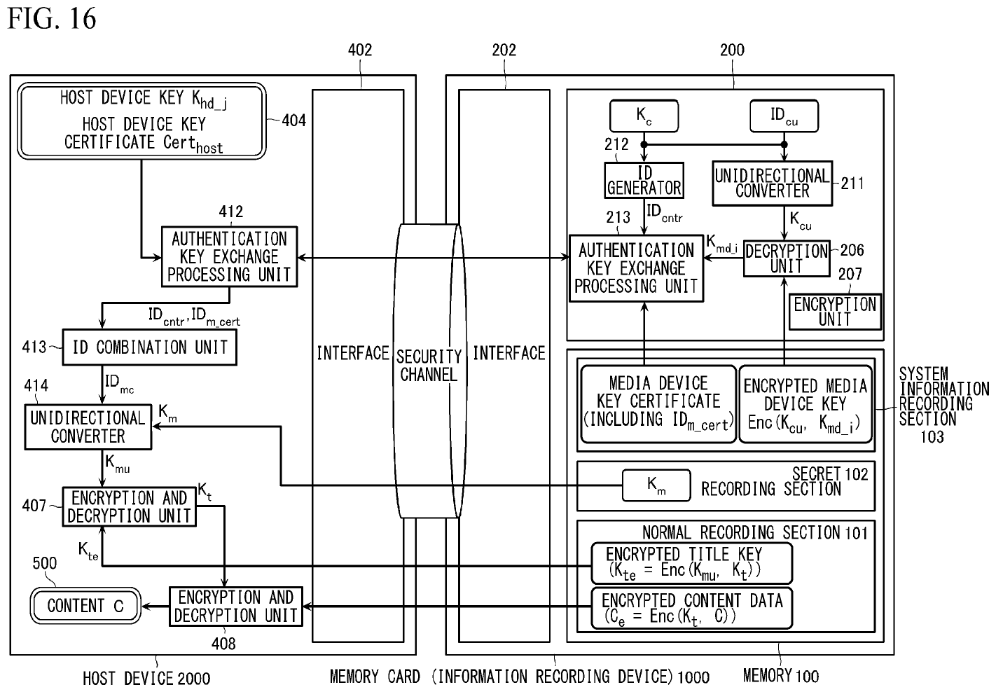

FIG. 16 is a block diagram showing the constitution of the information recording system of the third embodiment. In the present embodiment, the ID generator 212 transmits the generated controller unique ID (IDcntr) to the authentication key exchange processing unit 213 in the controller 200 rather than directly transmitting the generated controller unique ID (IDcntr) to the host device 2000. In addition, the controller unique ID (IDcntr) is used as one of parameters of the authentication key exchange process. In a case where the authentication key exchange process is completed, the controller unique ID (IDcntr) is transmitted to the ID combination unit 413 together with the media device key certificate ID (IDm_cert). The subsequent operation is the same as that of the first embodiment.

### Fourth Embodiment

Next, the fourth embodiment will be described. The present embodiment is different from the first embodiment in that instead of recording the media key Km in the secret recording section 102, the title key Kt is recorded in the secret recording section 102, the title key Kt is used with respect to the memory card unique ID (IDmc) to generate and record an authentication message (message authentication code: MAC). Note that the constitutions other than that described below is the same as those of the first embodiment.

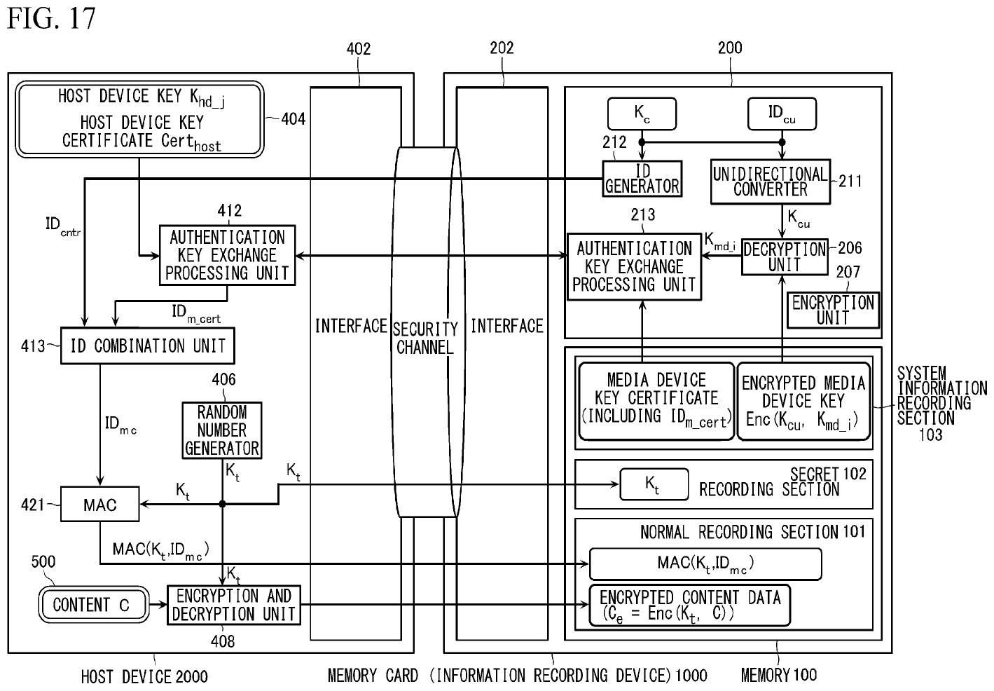

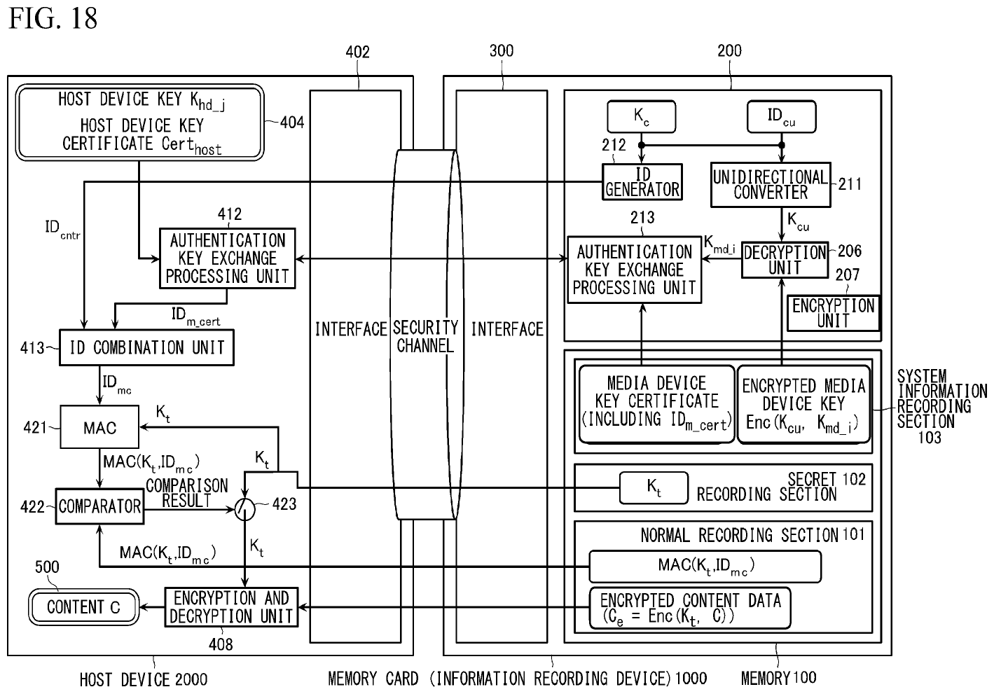

FIG. 17 is a block diagram for describing an operation of writing the content data C in the memory card 1000 in the fourth embodiment. In the present embodiment, instead of the encryption and decryption unit 407 and the unidirectional converter 414, the controller 400 of the host device 2000 includes an MAC generation unit 421, a comparator 422 (refer to FIG. 18), and a title key use permission unit 423 (refer to FIG. 18).

In the present embodiment, the host device 2000 generates the title key Kt by the random number generator 406. The generated title key Kt is recorded in the secret recording section 102 of the memory card 1000 through the secure channel and the interface units 402 and 202.

In addition, the host device 2000 generates the authentication message MAC(Kt, IDmc) from the title key Kt and the memory card unique ID (IDmc) obtained by the ID combination unit 413 using the MAC generation unit 421. As a calculation example of the authentication message MAC(Kt, IDmc), CMAC may be used. Note that details of the CMAC are described, for example, in “US Department of Commerce/National Institute of Standards and Technology, Recommendation for Block Cipher Modes of Operation: The CMAC Mode for Authentication, NIST Special Publication 800-38B, March 2005”. This document is incorporated by reference in its entirety.

The host device 2000 records the generated authentication message MAC(Kt, IDmc) in the normal recording section 101 of the memory card 1000. In addition, the host device 2000 encrypts the content data C using the title key Kt in the encryption and decryption unit 408, and generates the encrypted content data Ce=Enc(Kt, C). The host device 2000 records the generated encrypted content data Ce in the normal recording section 101 of the memory card 1000. Therefore, the recording operation of the content data C is completed.

FIG. 18 is a block diagram for describing an operation of reading the content data C from memory card 1000. In a case where the authentication key exchange process is completed and the secure channel is established, the access to the secret recording section 102 and the system information recording section 103 of the memory card 1000 becomes possible (that is, the designation of the logical address of the secret recording section 102 and the system information recording section 103 becomes possible).

In addition, in a case where the memory card 1000 receives the read command of the encrypted content data Ce from the host device 2000, the memory card 1000 reads the designated encrypted content data Ce and the authentication message MAC(Kt, IDmc) corresponding to the designated encrypted content data Ce from the normal recording section 101, and transmits the designated encrypted content data Ce and the authentication message MAC(Kt, IDmc) corresponding to the designated encrypted content data Ce to the host device 2000. In addition, the memory card 1000 reads the title key Kt corresponding to the designated encrypted content data Ce from the secret recording section 102, and transmits the title key Kt corresponding to the designated encrypted content data Ce to the host device 2000 through the secure channel. The title kcy Kt transmitted from the memory card 1000 to the host device 2000 is provided to the MAC generator 421 and the title key use permission unit 423 of the host device 2000.

The MAC generator 421 generates the authentication message MAC(Kt, IDmc) again using the provided title key Kt (the title key Kt read from the memory card 1000) and the above-described memory card unique ID (IDmc).

The comparator 422 compares the authentication message MAC(Kt, IDmc) generated again by the MAC generator 421 with the authentication message MAC(Kt, IDmc) read from the memory card 1000. That is, the comparator 422 determines whether or not the authentication message MAC(Kt, IDmc) generated again by the MAC generator 421 matches the authentication message MAC(Kt, IDmc) read from the memory card 1000. A comparison result (determination result) by the comparator 422 is output to the title key use permission unit 423.

In a case where the title key use permission unit 423 receives a signal indicating that the authentication message MAC(Kt, IDmc) generated again by the MAC generator 421 matches the authentication message MAC(Kt, IDmc) read from the memory card 1000 from the comparator 422 as the comparison result by the comparator 422, the title key use permission unit 423 permits decrypting the encrypted content data Ce using the title key Kt read from the memory card 1000 and outputs the title key Kt read from the memory card 1000 to the encryption and decryption unit 408. In this case, the encryption and decryption unit 408 decrypts the encrypted content data Ce using the title key Kt read from the memory card 1000 to obtain the content data C.

On the other hand, in a case where the title key use permission unit 423 does not receive the signal indicating that the authentication message MAC(Kt, IDmc) generated again by the MAC generator 421 matches the authentication message MAC(Kt, IDmc) read from the memory card 1000 from the comparator 422 as the comparison result by the comparator 422, the title key use permission unit 423 does not permit decrypting the encrypted content data Ce using the title key Kt read from the memory card 1000. In this case, the decryption of the encrypted content data Ce is not performed.

In the present embodiment, the title key Kt used for encrypting the content data C of the first standard is an example of each of the “first key information” and the “first secret information” instead of the first media key KmA in the first embodiment. That is, in the description of the first embodiment, the first media key KmA is able to be read as “the title key Kt used for encrypting the content data C of the first standard”. For example, “the title key Kt used for encrypting the content data C of the first standard” is recorded in the first area A1 of the secret recording section 102.

On the other hand, the title key Kt used for encrypting the content data C of the second standard is an example of each of the “second key information” and the “second secret information” instead of the second media key KmB in the first embodiment. That is, in the description of the first embodiment, the second media key KmB is able to be read as “the title key Kt used for encrypting the content data C of the second standard”. For example, “the title key Kt used for encrypting the content data C of the second standard” is recorded in the second area A2 of the secret recording section 102. Such a constitution is also able to improve the security level similarly to the first embodiment.

Although some embodiments and modified examples have been described above, these embodiments and modified examples are presented as examples and are not intended to limit the scope of the invention. These novel embodiments and modified examples can be implemented in other various forms, and various omissions, substitutions, changes, and combinations can be made without departing from the scope of the invention. These embodiments and modified examples thereof are included in the scope and the gist of the invention, and are included in the invention described in the claims and the equivalent scope thereof. For example, in the embodiment described above, the ID generator 212 generates the controller unique ID (IDcntr) on the basis of the pair of the controller key Kc and the controller unique ID (IDcu). Instead of this, the controller unique ID (IDcntr) may be generated on the basis of only the controller unique ID (IDcu). As long as another piece of unique information that is able to be disclosed outside is able to be generated in a case where the controller unique ID (IDcu) concealed by the controller 200 is concealed, any parameter can be used. However, the function used for generation is irreversible, such as a unidirectional function, is required to select one such as performing reverse calculation from the obtained control unique ID (IDcntr) and not obtaining an original control unique ID (IDcu).

All or a part of the functions of the controller 200 of the memory card 1000 described above and all or a part of the functions of the controller 400 of the host device 2000 may be realized by hardware (circuit unit; including a circuitry) such as an application specific integrated circuit (ASIC), a programmable logic device (PLD), or a field programmable gate array (FPGA), or may be realized by cooperation of software and hardware.

According to at least one embodiment described above, the information recording device is able to improve the security level by permitting the access to the first area of the secret recording section in a case where the first authentication process is performed and permitting the access to the second area of the secret recording section in a case where the second authentication process is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information recording device comprising:
a memory including a normal recording section and a secret recording section, the normal recording section being configured to record encrypted content data, the secret recording section including a first area and a second area, the first area being configured to, in a case where the content date is a first content data conforming to a first standard, record first key information used for decoding the first content data, the second area being configured to, in a case where the content data is a second content data conforming to a second standard, record second key information used for decoding the second content data; and
a controller configured to control the memory, configured to permit reading of the first key information from the first area in a case where a first authentication process is performed with a host device, and configured to permit reading of the second key information from the second area in a case where a second authentication process is performed with the host device, a data length of information used for authentication in the second authentication process being longer than a data length of information used for authentication in the first authentication process.

2. The information recording device of claim 1, wherein
the controller receives first information indicating an area accessible by the host device in the secret recording section in the first authentication process, and the controller does not permit the reading of the second key information in a case where the second authentication process is not performed even in a case where a position in the second area where the second key information is recorded is included in the area accessible by the host device indicated by the first information.

3. The information recording device of claim 2, wherein
the first information is certificate information of the host device, in which a digital signature is attached.

4. The information recording device of claim 1, wherein
the first authentication process and the second authentication process are key exchange authentication processes in which certificate information in which a digital signature is attached is exchanged between the host device and the information recording device to generate a shared key.

5. The information recording device of claim 1, wherein
the first area and the second area are defined by setting, on management information, an area in which access of the host device is permitted in a case where the first authentication process is performed and an area in which access of the host device is permitted in a case where the second authentication process is performed.

6. The information recording device of claim 5, wherein
the secret recording section is one area in which logical addresses are continuous over the first area and the second area.

7. The information recording device of claim 1, wherein,
even in a case where the second authentication process is performed, the controller does not permit the reading of the first key information from the first area in a case where the first authentication process is not performed.

8. The information recording device of claim 1, wherein,
in a case where the second authentication process is performed, the controller permits the reading of the first key information from the first area even though the first authentication process is not performed.

9. An information recording device comprising:
a memory including a secret recording section, the secret recording section including a first area and a second area; and
a controller configured to control the memory, configured to permit access to the first area in a case where a first authentication process related to the secret recording section is performed, and configured to permit access to the second area in a case where a second authentication process related to the secret recording section is performed.

10. The information recording device of claim 9, wherein
the second authentication process is higher in security level than the first authentication process.

11. The information recording device of claim 9, wherein
the first area is configured to record information related to content data conforming to a first standard, and
the second area is configured to record information related to content data conforming to a second standard.

12. A host device comprising:
an interface configured to connect to an information recording device, the information recording device including a memory, the memory including a secret recording section; and
a controller configured to perform a first authentication process related to the secret recording section with the information recording device in a case where information is to be written in a first area of the secret recording section and configured to perform a second authentication process related to the secret recording section with the information recording device in a case where information is to be written in a second area of the secret recording section.

13. The host device of claim 12, wherein
in a case where first concealment information related to content data conforming to a first standard is to be written in the secret recording section, the controller performs the first authentication process and writes the first concealment information in the first area, and
in a case where second concealment information related to content data conforming to a second standard is to be written in the secret recording section, the controller performs the second authentication process and writes the second concealment information in the second area.
